(19) United States
(12) Patent Application Publication
(10) Pub. No.: US 2026/0012891 A1
(43) Pub. Date: Jan. 8, 2026

(54) METHOD AND APPARATUS SUPPORTING MULTI-BEAM OPERATION FOR LOW-POWER SIGNAL

(71) Applicant: Electronics and Telecommunications Research Institute, Daejeon (KR)

(72) Inventors: Junghoon LEE, Daejeon (KR); Ji Hyung KIM, Daejeon (KR); Cheulsoon KIM, Daejeon (KR); Sung-Hyun MOON, Daejeon (KR); Hoiyoon JUNG, Daejeon (KR)

(21) Appl. No.: 19/260,215

(22) Filed: Jul. 3, 2025

(30) Foreign Application Priority Data
Jul. 3, 2024 (KR) 10-2024-0087675
Aug. 9, 2024 (KR) 10-2024-0106737
Oct. 4, 2024 (KR) 10-2024-0135076
Mar. 25, 2025 (KR) 10-2025-0037830
Apr. 25, 2025 (KR) 10-2025-0054434
Jun. 5, 2025 (KR) 10-2025-0074012
Jul. 2, 2025 (KR) 10-2025-0088765

(51) Int. Cl. H04W 52/02; H04L 1/1607

(52) U.S. Cl. CPC H04W 52/0235; H04L 1/1614

(57) ABSTRACT

Disclosed are a method and an apparatus for supporting multi-beam operations of low-power signals. A method of a user equipment (UE) may comprise: receiving, from a base station, a first bitmap indicating whether a synchronization signal block (SSB) is transmitted; receiving the SSB from the base station based on the first bitmap; receiving, from the base station, a second bitmap indicating whether a low-power (LP) signal is transmitted; and receiving the LP signal from the base station based on the second bitmap, wherein the second bitmap indicates a beam through which the LP signal is transmitted, and the beam is configured based on an actually transmitted SSB indicated by the first bitmap.

### CROSS-REFERENCE TO RELATED APPLICATIONS

This application claims priority to Korean Patent Applications No. 10-2024-0087675, filed on Jul. 3, 2024, No. 10-2024-0106737, filed on Aug. 9, 2024, No. 10-2024-0135076, filed on Oct. 4, 2024, No. 10-2025-0037830, filed on Mar. 25, 2025, No. 10-2025-0054434, filed on Apr. 25, 2025, No. 10-2025-0074012, filed on Jun. 5, 2025, and No. 10-2025-0088765, filed on Jul. 2, 2025, with the Korean Intellectual Property Office (KIPO), the entire contents of which are hereby incorporated by reference.

### BACKGROUND

### 1. Technical Field

The present disclosure relates to a communication technique, and more particularly, to a technique for supporting multi-beam operations for a low-power signal.

### 2. Related Art

The communication system (e.g., a new radio (NR) communication system) using a higher frequency band (e.g., a frequency band of 6 GHz or above) than a frequency band (e.g., a frequency band of 6 GHz or below) of the long term evolution (LTE) communication system (or, LTE-A communication system) is being considered for processing of soaring wireless data. The NR system may support not only a frequency band of 6 GHz or below, but also a frequency band of 6 GHz or above, and may support various communication services and scenarios compared to the LTE system. In addition, requirements of the NR system may include enhanced Mobile BroadBand (eMBB), Ultra Reliable Low Latency Communication (URLLC), and Massive Machine Type Communication (mMTC).

Meanwhile, low-power operations may be supported in a communication system. A terminal supporting low-power operations may operate in an active mode or a sleep mode. A base station may transmit a low-power signal (e.g., low-power wake-up signal) to the terminal for waking up the terminal operating in the sleep mode. When the low-power signal is received from the base station, the operation mode of the terminal may transition from the sleep mode to the active mode. The terminal may perform a monitoring operation in a specific occasion to receive the low-power signal. To support the above-described operations, a method for indicating the specific occasion for monitoring the low-power signal to the terminal may be required. When the base station indicates the specific occasion for monitoring the low-power signal to the terminal through separate signaling, signaling overhead may increase. A signaling method for solving the above-described problem may be required.

### SUMMARY

The present disclosure for resolving the above-described problems is directed to providing a method and an apparatus for supporting multi-beam operations for a low-power signal.

A method of a user equipment (UE), according to exemplary embodiments of the present disclosure, may comprise: receiving, from a base station, a first bitmap indicating whether a synchronization signal block (SSB) is transmitted; receiving the SSB from the base station based on the first bitmap; receiving, from the base station, a second bitmap indicating whether a low-power (LP) signal is transmitted; and receiving the LP signal from the base station based on the second bitmap, wherein the second bitmap indicates a beam through which the LP signal is transmitted, and the beam is configured based on an actually transmitted SSB indicated by the first bitmap.

A bit in the second bitmap corresponding to a bit set to a first value in the first bitmap may not be used to indicate whether the LP signal is transmitted, a bit in the second bitmap corresponding to a bit set to a second value in the first bitmap may be used to indicate whether the LP signal is transmitted, the first value may indicate that the SSB is not transmitted, and the second value may indicate that the SSB is transmitted.

A number of bits equal to a number of bits set to a second value in the first bitmap may be used in the second bitmap to indicate whether the LP signal is transmitted, a bit set to a first value in the first bitmap may indicate that the SSB is not transmitted, and a bit set to a second value in the first bitmap may indicate that the SSB is transmitted.

The bits used to indicate whether the LP signal is transmitted in the second bitmap may be configured starting from a most significant bit (MSB) or a least significant bit (LSB).

The second bitmap may be configured based on values of respective bits in the first bitmap, and a size of the second bitmap may be equal to a size of the first bitmap.

The LP signal may be a low-power wake-up signal (LP-WUS) or a low-power synchronization signal (LP-SS), and the LP-WUS may have a one-to-one mapping relationship with the LP-SS.

The UE may operate in an active state or a sleep state, the UE in the active state may receive at least one of the first bitmap, the SSB, or the second bitmap, and the UE in the sleep state may receive the LP signal.

The UE may operate in a radio resource control (RRC) idle mode or RRC inactive mode.

A method of a base station, according to exemplary embodiments of the present disclosure, may comprise: transmitting, to a user equipment (UE), a first bitmap indicating whether a synchronization signal block (SSB) is transmitted; transmitting the SSB to the UE based on the first bitmap; transmitting, to the UE, a second bitmap indicating whether a low-power (LP) signal is transmitted; and transmitting the LP signal to the UE based on the second bitmap, wherein the second bitmap indicates a beam through which the LP signal is transmitted, and the beam is configured based on an actually transmitted SSB indicated by the first bitmap.

A bit in the second bitmap corresponding to a bit set to a first value in the first bitmap may not be used to indicate whether the LP signal is transmitted, a bit in the second bitmap corresponding to a bit set to a second value in the first bitmap may be used to indicate whether the LP signal is transmitted, the first value may indicate that the SSB is not transmitted, and the second value may indicate that the SSB is transmitted.

A number of bits equal to a number of bits set to a second value in the first bitmap may be used in the second bitmap to indicate whether the LP signal is transmitted, a bit set to a first value in the first bitmap may indicate that the SSB is not transmitted, and a bit set to a second value in the first bitmap may indicate that the SSB is transmitted.

The bits used to indicate whether the LP signal is transmitted in the second bitmap may be configured starting from a most significant bit (MSB) or a least significant bit (LSB).

The second bitmap may be configured based on values of respective bits in the first bitmap, and a size of the second bitmap may be equal to a size of the first bitmap.

The LP signal may be a low-power wake-up signal (LP-WUS) or a low-power synchronization signal (LP-SS), and the LP-WUS may have a one-to-one mapping relationship with the LP-SS.

The UE may operate in an active state or a sleep state, the UE in the active state may receive at least one of the first bitmap, the SSB, or the second bitmap, and the UE in the sleep state may receive the LP signal.

The UE may operate in a radio resource control (RRC) idle mode or RRC inactive mode.

A user equipment (UE), according to exemplary embodiments of the present disclosure, may comprise at least one processor, wherein the at least one processor may cause the UE to perform: receiving, from a base station, a first bitmap indicating whether a synchronization signal block (SSB) is transmitted; receiving the SSB from the base station based on the first bitmap; receiving, from the base station, a second bitmap indicating whether a low-power (LP) signal is transmitted; and receiving the LP signal from the base station based on the second bitmap, wherein the second bitmap indicates a beam through which the LP signal is transmitted, and the beam is configured based on an actually transmitted SSB indicated by the first bitmap.

A bit in the second bitmap corresponding to a bit set to a first value in the first bitmap may not be used to indicate whether the LP signal is transmitted, a bit in the second bitmap corresponding to a bit set to a second value in the first bitmap may be used to indicate whether the LP signal is transmitted, the first value may indicate that the SSB is not transmitted, and the second value may indicate that the SSB is transmitted.

A number of bits equal to a number of bits set to a second value in the first bitmap may be used in the second bitmap to indicate whether the LP signal is transmitted, a bit set to a first value in the first bitmap may indicate that the SSB is not transmitted, and a bit set to a second value in the first bitmap may indicate that the SSB is transmitted.

The bits used to indicate whether the LP signal is transmitted in the second bitmap may be configured starting from a most significant bit (MSB) or a least significant bit (LSB).

According to the present disclosure, a base station can transmit a first bitmap indicating whether synchronization signal blocks (SSBs) are transmitted to a terminal, and can transmit a second bitmap indicating whether low-power (LP) signals are transmitted to the terminal. The second bitmap can be configured based on the first bitmap. In other words, the second bitmap may indicate LP occasions in which LP signals are transmitted, and the LP occasions may be configured based on actually-transmitted SSBs indicated by the first bitmap. The terminal can receive the first bitmap and the second bitmap from the base station, can receive the SSB(s) from the base station based on the first bitmap, and may receive the LP signal(s) from the base station based on the second bitmap. Based on the above-described methods, the occasions in which the LP signals are actually transmitted may be clearly indicated to the terminal, and since the second bitmap is configured based on the first bitmap, signaling overhead for the second bitmap (e.g., the occasions in which the LP signals are actually transmitted) may be reduced. Therefore, the performance of the communication system can be improved.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of a type 1 frame.

FIG. 4 is a conceptual diagram illustrating exemplary embodiments of a type 2 frame.

FIG. 5 is a conceptual diagram illustrating exemplary embodiments of a first transmission method of SSBs in a communication system.

FIG. 6 is a conceptual diagram illustrating exemplary embodiments of an SSB in a communication system.

FIG. 7 is a conceptual diagram illustrating exemplary embodiments of a second transmission method of SSBs in a communication system.

FIG. 8 is a conceptual diagram illustrating exemplary embodiments of SSB burst configuration.

FIG. 9 is a conceptual diagram illustrating exemplary embodiments of RMSI signaling for actual SSB transmission.

FIG. 10A is a conceptual diagram illustrating an RMSI CORESET mapping pattern #1 in a communication system.

FIG. 10B is a conceptual diagram illustrating an RMSI CORESET mapping pattern #2 in a communication system.

FIG. 10C is a conceptual diagram illustrating an RMSI CORESET mapping pattern #3 in a communication system.

FIG. 11A is a conceptual diagram illustrating a configuration of Type 0 CSS slots corresponding to an SSB index when M is ½.

FIG. 11B is a conceptual diagram illustrating a configuration of Type 0 CSS slots corresponding to an SSB index when M is 1.

FIG. 11C is a conceptual diagram illustrating a configuration of Type 0 CSS slots corresponding to an SSB index when M is 2.

FIGS. 12A and 12B are conceptual diagrams illustrating exemplary embodiments of multi-beam operations for LP signals in the RRC idle/inactive mode.

FIGS. 13A and 13B are conceptual diagrams illustrating exemplary embodiments of a PDSCH scheduling offset due to beam switching delay.

FIG. 14 is a conceptual diagram illustrating exemplary embodiments of a beam application time (BAT).

FIGS. 15A, 15B, 15C, and 15D are conceptual diagrams illustrating exemplary embodiments of LP beam application for a PDSCH.

FIGS. 16A and 16B are conceptual diagrams illustrating exemplary embodiments of LP beam application for a PDCCH.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, “an operation (e.g., transmission operation) is configured” may mean that “configuration information (e.g., information element(s) or parameter(s)) for the operation and/or information indicating to perform the operation is signaled”. “Information element(s) (e.g., parameter(s)) are configured” may mean that “corresponding information element(s) are signaled”. The signaling may be at least one of system information (SI) signaling (e.g., transmission of system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)).

In the present disclosure, a phrase including “when ˜” may be expressed as a phrase including “based on ˜” or “in response to ˜”. In other words, a phrase including “when ˜” may be interpreted as being the same as or similar to a phrase including “based on ˜” or “in response to ˜”.

In the present disclosure, a transmission time may mean a transmission start time or a transmission end time, and a reception time may mean a reception start time or a reception end time. A time point may refer to a time. In other words, ‘time point’ and ‘time’ may be used with the same meaning.

Hereinafter, even when a method (e.g., transmission or reception of a signal) performed at a first communication node among communication nodes is described, a corresponding second communication node may perform a method (e.g., reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

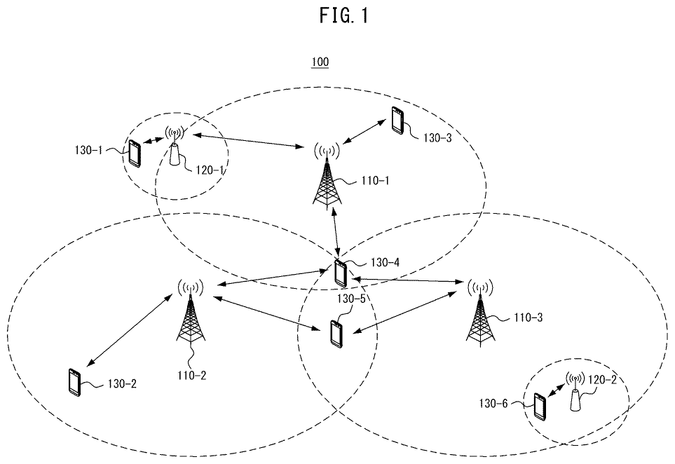

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g., a serving gateway (S-GW), a packet data network (PDN) gateway (P-GW), and a mobility management entity (MME)). When the communication system 100 is a 5G communication system (e.g., new radio (NR) system), the core network may include an access and mobility management function (AMF), a user plane function (UPF), a session management function (SMF), and the like.

The plurality of communication nodes 110 to 130 may support a communication protocol defined by the 3rd generation partnership project (3GPP) specifications (e.g., LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may have the following structure.

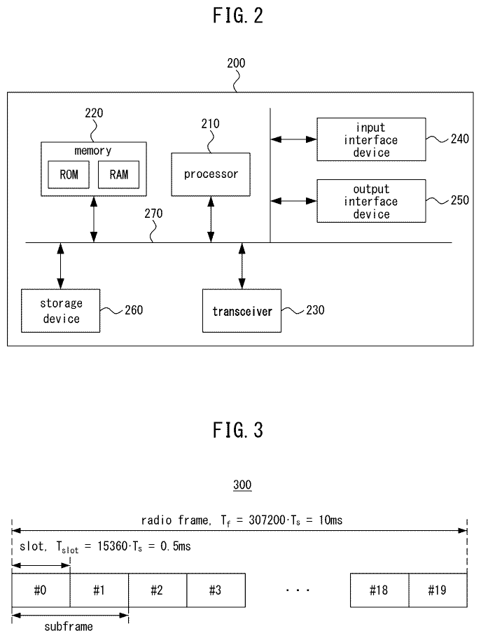

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), a evolved Node-B (eNB), a gNB, an advanced base station (ABS), a high reliability-base station (HR-BS), a base transceiver station (BTS), a radio base station, a radio transceiver, an access point, an access node, a radio access station (RAS), a mobile multihop relay-base station (MMR-BS), a relay station (RS), an advanced relay station (ARS), a high reliability-relay station (HR-RS), a home NodeB (HNB), a home eNodeB (HeNB), a road side unit (RSU), a radio remote head (RRH), a transmission point (TP), a transmission and reception point (TRP), or the like.

Each of the plurality of terminals 130-1, 130-2, 130-3, 130-4, 130-5, and 130-6 may refer to a user equipment (UE), a terminal equipment (TE), an advanced mobile station (AMS), a high reliability-mobile station (HR-MS), a terminal, an access terminal, a mobile terminal, a station, a subscriber station, a mobile station, a portable subscriber station, a node, a device, an on-board unit (OBU), or the like.

Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, device-to-device (D2D) communication (or, proximity services (ProSe)), Internet of Things (IoT) communications, dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, the communication system may support three types of frame structures. A type 1 frame structure may be applied to a frequency division duplex (FDD) communication system, a type 2 frame structure may be applied to a time division duplex (TDD) communication system, and a type 3 frame structure may be applied to an unlicensed band based communication system (e.g., a licensed assisted access (LAA) communication system).

FIG. 3 is a conceptual diagram illustrating exemplary embodiments of a type 1 frame.

Referring to FIG. 3, a radio frame 300 may comprise 10 subframes, and a subframe may comprise 2 slots. Thus, the radio frame 300 may comprise 20 slots (e.g., slot #0, slot #1, slot #2, slot #3, . . . , slot #18, and slot #19). The length T_{f} of the radio frame 300 may be 10 milliseconds (ms). The length of the subframe may be 1 ms, and the length Tₛₗₒₜ of a slot may be 0.5 ms. Here, Tₛ may indicate a sampling time, and may be 1/30,720,000 s.

The slot may be composed of a plurality of OFDM symbols in the time domain, and may be composed of a plurality of resource blocks (RBs) in the frequency domain. The RB may be composed of a plurality of subcarriers in the frequency domain. The number of OFDM symbols constituting the slot may vary depending on configuration of a cyclic prefix (CP). The CP may be classified into a normal CP and an extended CP. If the normal CP is used, the slot may be composed of 7 OFDM symbols, in which case the subframe may be composed of 14 OFDM symbols. If the extended CP is used, the slot may be composed of 6 OFDM symbols, in which case the subframe may be composed of 12 OFDM symbols.

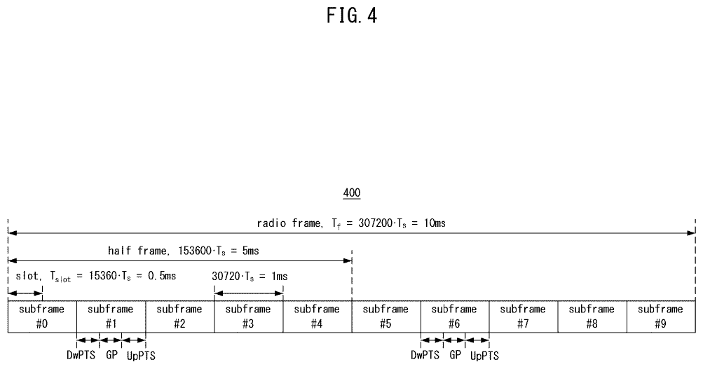

FIG. 4 is a conceptual diagram illustrating exemplary embodiments of a type 2 frame.

Referring to FIG. 4, a radio frame 400 may comprise two half frames, and a half frame may comprise 5 subframes. Thus, the radio frame 400 may comprise 10 subframes. The length T_{f} of the radio frame 400 may be 10 ms. The length of the half frame may be 5 ms. The length of the subframe may be 1 ms. Here, Tₛ may be 1/30,720,000 s.

The radio frame 400 may include at least one downlink subframe, at least one uplink subframe, and a least one special subframe. Each of the downlink subframe and the uplink subframe may include two slots. The length Tₛₗₒₜ of a slot may be 0.5 ms. Among the subframes included in the radio frame 400, each of the subframe #1 and the subframe #6 may be a special subframe. For example, when a switching periodicity between downlink and uplink is 5 ms, the radio frame 400 may include 2 special subframes. Alternatively, the switching periodicity between downlink and uplink is 10 ms, the radio frame 400 may include one special subframe. The special subframe may include a downlink pilot time slot (DwPTS), a guard period (GP), and an uplink pilot time slot (UpPTS).

The downlink pilot time slot may be regarded as a downlink interval and may be used for cell search, time and frequency synchronization acquisition of the terminal, channel estimation, and the like. The guard period may be used for resolving interference problems of uplink data transmission caused by delay of downlink data reception. Also, the guard period may include a time required for switching from the downlink data reception operation to the uplink data transmission operation. The uplink pilot time slot may be used for uplink channel estimation, time and frequency synchronization acquisition, and the like. Transmission of a physical random access channel (PRACH) or a sounding reference signal (SRS) may be performed in the uplink pilot time slot.

The lengths of the downlink pilot time slot, the guard period, and the uplink pilot time slot included in the special subframe may be variably adjusted as needed. In addition, the number and position of each of the downlink subframe, the uplink subframe, and the special subframe included in the radio frame 400 may be changed as needed.

In the communication system, a transmission time interval (TTI) may be a basic time unit for transmitting coded data through a physical layer. A short TTI may be used to support low latency requirements in the communication system. The length of the short TTI may be less than 1 ms. The conventional TTI having a length of 1 ms may be referred to as a base TTI or a regular TTI. That is, the base TTI may be composed of one subframe. In order to support transmission on a base TTI basis, signals and channels may be configured on a subframe basis. For example, a cell-specific reference signal (CRS), a physical downlink control channel (PDCCH), a physical downlink shared channel (PDSCH), a physical uplink control channel (PUCCH), a physical uplink shared channel (PUSCH), and the like may exist in each subframe.

On the other hand, a synchronization signal (e.g., a primary synchronization signal (PSS) and a secondary synchronization signal (SSS)) may exist for every 5 subframes, and a physical broadcast channel (PBCH) may exist for every 10 subframes. Also, each radio frame may be identified by an SFN, and the SFN may be used for defining transmission of a signal (e.g., a paging signal, a reference signal for channel estimation, a signal for channel state information, etc.) longer than one radio frame. The periodicity of the SFN may be 1024.

In the LTE system, the PBCH may be a physical layer channel used for transmission of system information (e.g., master information block (MIB)). The PBCH may be transmitted every 10 subframes. That is, the transmission periodicity of the PBCH may be 10 ms, and the PBCH may be transmitted once in the radio frame. The same MIB may be transmitted during 4 consecutive radio frames, and after 4 consecutive radio frames, the MIB may be changed according to a situation of the LTE system. The transmission period for which the same MIB is transmitted may be referred to as a ‘PBCH TTI’, and the PBCH TTI may be 40 ms. That is, the MIB may be changed for each PBCH TTI.

The MIB may be composed of 40 bits. Among the 40 bits constituting the MIB, 3 bits may be used to indicate a system band, 3 bits may be used to indicate physical hybrid automatic repeat request (ARQ) indicator channel (PHICH) related information, 8 bits may be used to indicate an SFN, 10 bits may be configured as reserved bits, and 16 bits may be used for a cyclic redundancy check (CRC).

The SFN for identifying the radio frame may be composed of a total of 10 bits (B9 to B0), and the most significant bits (MSBs) 8 bits (B9 to B2) among the 10 bits may be indicated by the PBCH (i.e., MIB). The MSBs 8 bits (B9 to B2) of the SFN indicated by the PBCH (i.e., MIB) may be identical during 4 consecutive radio frames (i.e., PBCH TTI). The least significant bits (LSBs) 2 bits (B1 to B0) of the SFN may be changed during 4 consecutive radio frames (i.e., PBCH TTI), and may not be explicitly indicated by the PBCH (i.e., MIB). The LSBs (2 bits (B1 to B0)) of the SFN may be implicitly indicated by a scrambling sequence of the PBCH (hereinafter referred to as ‘PBCH scrambling sequence’).

A gold sequence generated by being initialized by a cell ID may be used as the PBCH scrambling sequence, and the PBCH scrambling sequence may be initialized for each four consecutive radio frames (e.g., each PBCH TTI) based on an operation of ‘mod (SFN, 4)’. The PBCH transmitted in a radio frame corresponding to an SFN with LSBs 2 bits (B1 to B0) set to ‘00’ may be scrambled by the gold sequence generated by being initialized by the cell ID. Thereafter, the gold sequences generated according to the operation of ‘mod (SFN, 4)’ may be used to scramble the PBCH transmitted in the radio frames corresponding to SFNs with LSBs 2 bits (B1 to B0) set to ‘01’, ‘10’, and ‘11’.

Accordingly, the terminal having acquired the cell ID in the initial cell search process may identify the value of the LSBs 2 bits (B1 to B0) of the SFN (e.g., ‘00’, ‘01’, ‘10’, or ‘11’) based on the PBCH scramble sequence obtained in the decoding process for the PBCH (i.e., MIB). The terminal may use the LSBs 2 bits (B1 to B0) of the SFN obtained based on the PBCH scrambling sequence and the MSBs 8 bits (B9 to B2) of the SFN indicated by the PBCH (i.e., MIB) so as to identify the SFN (i.e., the entire bits B9 to B0 of the SFN).

On the other hand, the communication system may support not only a high transmission rate but also technical requirements for various service scenarios. For example, the communication system may support an enhanced mobile broadband (eMBB) service, an ultra-reliable low-latency communication (URLLC) service, a massive machine type communication (mMTC) service, and the like.

The subcarrier spacing of the communication system (e.g., OFDM-based communication system) may be determined based on a carrier frequency offset (CFO) and the like. The CFO may be generated by a Doppler effect, a phase drift, or the like, and may increase in proportion to an operation frequency. Therefore, in order to prevent the performance degradation of the communication system due to the CFO, the subcarrier spacing may increase in proportion to the operation frequency. On the other hand, as the subcarrier spacing increases, a CP overhead may increase. Therefore, the subcarrier spacing may be configured based on a channel characteristic, a radio frequency (RF) characteristic, etc. according to a frequency band.

The communication system may support numerologies defined in Table 1 below.

TABLE 1

| Numerology (μ) | 0 | 1 | 2 | 3 | 4 | 5 |
|---|---|---|---|---|---|---|
| Subcarrier | 15 kHz | 30 kHz | 60 kHz | 120 kHz | 240 kHz | 480 kHz |
| spacing | | | | | | |
| OFDM symbol | 66.7 | 33.3 | 16.7 | 8.3 | 4.2 | 2.1 |
| length [us] | | | | | | |
| CP length [us] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

For example, the subcarrier spacing of the communication system may be configured to 15 kHz, 30 kHz, 60 kHz, or 120 kHz. The subcarrier spacing of the LTE system may be 15 kHz, and the subcarrier spacing of the NR system may be 1, 2, 4, or 8 times the conventional subcarrier spacing of 15 kHz. If the subcarrier spacing increases by exponentiation units of 2 of the conventional subcarrier spacing, the frame structure can be easily designed.

The communication system may support FR1 as well as FR2. The FR2 may be classified into FR2-1 and FR2-2. The FR1 may be a frequency band of 6 GHz or below, the FR2-1 may be a frequency band of 24.25 to 52.6, and the FR2-2 may be a frequency band of 52.6 to 71 GHz. In an exemplary embodiment, the FR2 may be the FR2-1, the FR2-1, or a frequency band including the FR2-1 and FR2-2. In each of the FR1, FR2-1, and FR2-2, subcarrier spacings available for data transmission may be defined as shown in Table 2 below. In each of the FR1, the FR2-1, and the FR2-2, SCSs available for synchronization signal block (SSB) transmission may be defined as shown in Table 3 below. In each of the FR1, the FR2-1, and the FR2-2, SCSs available for RACH transmission (e.g., Msg1 or Msg-A) may be defined as shown in Table 4 below.

TABLE 2
data

| FR1 | FR2-1 | FR2-2 |
|---|---|---|
| 15 kHz, 30 kHz, | 60 kHz, 120 kHz | 120 kHz, 480 kHz, |
| 60 kHz (optional) | | 960 kHz |

TABLE 3
SSB

| FR1 | FR2-1 | FR2-2 |
|---|---|---|
| 15 kHz, 30 kHz | 120 kHz, 240 kHz | 120 kHz, 480 kHz, |
| | | 960 kHz |

TABLE 4
RACH

| FR1 | FR2-1 | FR2-2 |
|---|---|---|
| 1.25 kHz, 5 kHz, | 60 kHz, 120 kHz | 120 kHz, 480 kHz, |
| 15 kHz, 30 kHz | | 960 kHz |

The communication system may support a wide frequency band (e.g., several hundred MHz to tens of GHz). Since the diffraction characteristic and the reflection characteristic of the radio wave are poor in a high frequency band, a propagation loss (e.g., path loss, reflection loss, and the like) in a high frequency band may be larger than a propagation loss in a low frequency band. Therefore, a cell coverage of a communication system supporting a high frequency band may be smaller than a cell coverage of a communication system supporting a low frequency band. In order to solve such the problem, a beamforming scheme based on a plurality of antenna elements may be used to increase the cell coverage in the communication system supporting a high frequency band.

The beamforming scheme may include a digital beamforming scheme, an analog beamforming scheme, a hybrid beamforming scheme, and the like. In the communication system using the digital beamforming scheme, a beamforming gain may be obtained using a plurality of RF paths based on a digital precoder or a codebook. In the communication system using the analog beamforming scheme, a beamforming gain may be obtained using analog RF devices (e.g., phase shifter, power amplifier (PA), variable gain amplifier (VGA), and the like) and an antenna array.

Because of the need for expensive digital to analog converters (DACs) or analog to digital converters (ADCs) for digital beamforming schemes and transceiver units corresponding to the number of antenna elements, the complexity of antenna implementation may be increased to increase the beamforming gain. In case of the communication system using the analog beamforming scheme, since a plurality of antenna elements are connected to one transceiver unit through phase shifters, the complexity of the antenna implementation may not increase greatly even if the beamforming gain is increased. However, the beamforming performance of the communication system using the analog beamforming scheme may be lower than the beamforming performance of the communication system using the digital beamforming scheme. Further, in the communication system using the analog beamforming scheme, since the phase shifter is adjusted in the time domain, frequency resources may not be efficiently used. Therefore, a hybrid beamforming scheme, which is a combination of the digital scheme and the analog scheme, may be used.

When the cell coverage is increased by the use of the beamforming scheme, common control channels and common signals (e.g., reference signal and synchronization signal) for all terminals belonging to the cell coverage as well as control channels and data channels for each terminal may also be transmitted based on the beamforming scheme. In this case, the common control channels and the common signals for all terminals belonging to the cell coverage may be transmitted based on a beam sweeping scheme.

In addition, in the NR system, a synchronization signal/physical broadcast channel (SS/PBCH) block may also be transmitted in a beam sweeping scheme. The SS/PBCH block may be composed of a PSS, an SSS, a PBCH, and the like. In the SS/PBCH block, the PSS, the SSS, and the PBCH may be configured in a time division multiplexing (TDM) manner. The SS/PBCH block may be referred also to as an ‘SS block (SSB)’. One SS/PBCH block may be transmitted using N consecutive OFDM symbols. Here, N may be an integer equal to or greater than 4. The base station may periodically transmit the SS/PBCH block, and the terminal may acquire frequency/time synchronization, a cell ID, system information, and the like based on the SS/PBCH block received from the base station. The SS/PBCH block may be transmitted as follows.

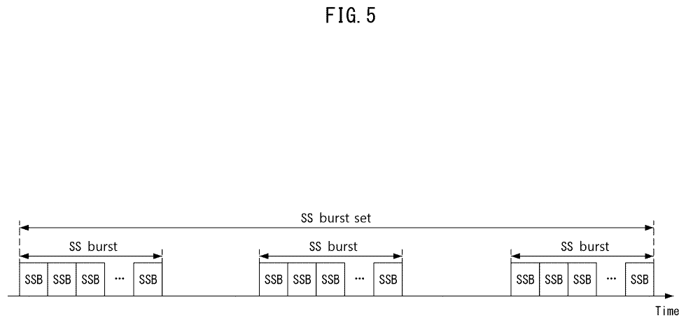

FIG. 5 is a conceptual diagram illustrating exemplary embodiments of a first transmission method of SSBs in a communication system.

Referring to FIG. 5, one or more SSBs (SS blocks) may be transmitted in a beam sweeping scheme within an SS burst set. Up to L SSBs may be transmitted within one SS burst set. L may be an integer equal to or greater than 2, and may be defined in the 3GPP standard. Depending on a region of a system frequency, L may vary. Within the SS burst set, the SSBs may be located consecutively or distributedly. The consecutive SSBs may be referred to as an ‘SS/PBCH block burst’ or ‘SSB burst’. The SS burst set may be repeated periodically, and system information (e.g., MIB) transmitted through the PBCHs of the SSBs within the SS burst set may be the same. An index of the SSB, an index of the SSB burst, an index of an OFDM symbol, an index of a slot, and the like may be indicated explicitly or implicitly by the PBCH.

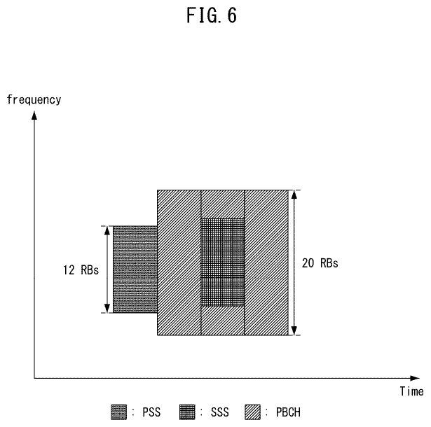

FIG. 6 is a conceptual diagram illustrating exemplary embodiments of an SSB in a communication system.

Referring to FIG. 6, signals and a channel are arranged within one SSB in the order of ‘PSS→PBCH→SSS→PBCH’. The PSS, SSS, and PBCH within the SS/PBCH block may be configured in a TDM scheme. In a symbol where the SSS is located, the PBCH may be located in frequency resources above the SSS and frequency resources below the SSS. When the maximum number of SSBs is 8 in the sub-6GHZ frequency band, an SSB index may be identified based on a demodulation reference signal used for demodulating the PBCH (hereinafter, referred to as ‘PBCH DMRS’). When the maximum number of SSBs is 64 in the above-6GHz frequency band, LSB 3 bits of 6 bits representing the SSB index may be identified based on the PBCH DMRS, and the remaining MSB 3 bits may be identified based on a payload of the PBCH.

The maximum system bandwidth that can be supported in the NR system may be 400 MHz. The size of the maximum bandwidth that can be supported by the terminal may vary depending on the capability of the terminal. Therefore, the terminal may perform an initial access procedure (e.g., initial connection procedure) by using some of the system bandwidth of the NR system supporting a wide band. In order to support access procedures of terminals supporting various sizes of bandwidths, SSBs may be multiplexed in the frequency domain within the system bandwidth of the NR system supporting a wide band. In this case, the SSBs may be transmitted as follows.

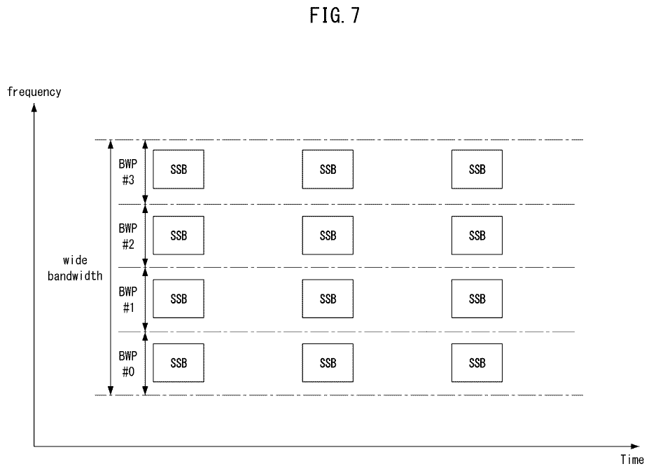

FIG. 7 is a conceptual diagram illustrating exemplary embodiments of a second transmission method of SSBs in a communication system.

Referring to FIG. 7, a wideband component carrier (CC) may include a plurality of bandwidth parts (BWPs). For example, the wideband CC may include 4 BWPs. The base station may transmit SSBs in the respective BWPs #0 to #3 belonging to the wideband CC. The terminal may receive the SSB(s) from one or more BWPs of the BWPs #0 to #3, and may perform an initial access procedure using the received SSB(s).

After detecting the SSB, the terminal may acquire system information (e.g., remaining minimum system information (RMSI)), and may perform a cell access procedure based on the system information. The RMSI may be transmitted on a PDSCH scheduled by a PDCCH. Configuration information of a control resource set (CORESET) in which the PDCCH including scheduling information of the PDSCH through which the RMSI is transmitted may be transmitted on a PBCH within the SSB. A plurality of SSBs may be transmitted in the entire system band, and one or more SSBs among the plurality of SSBs may be SSB(s) associated with the RMSI. The remaining SSBs may not be associated with the RMSI. The SSB associated with the RMSI may be defined as a ‘cell-defining (CD)-SSB’. The terminal may perform a cell search procedure and an initial access procedure by using the CD-SSB. The SSB not associated with the RMSI may be used for a synchronization procedure and/or a measurement procedure in the corresponding BWP. The SSB not associated with the RMSI may be defined as a ‘non-cell-defining SSB’. The non-cell-defining SSB may be referred to as an ‘NCD-SSB’. The BWP(s) through which the SSBs are transmitted may be limited to one or more BWPs within a wide bandwidth.

The positions at which the SSBs are transmitted in the time domain may be defined differently according to an SCS and a value of L. In exemplary embodiments, the SCS may mean a subcarrier size. The SSB may be transmitted in some symbols within one slot, and a short UL transmission (e.g., uplink control information (UCI) transmission) may be performed in the remaining symbols not used for the SSB transmission within one slot. When the SSB is transmitted in radio resources to which a large SCS (e.g., 120 kHz SCS or 240 KHz SCS) is applied, a gap may be configured in the middle of consecutive slots including the SSB so that a long UL transmission (e.g., transmission of URLLC traffic) can be performed at least every 1 ms.

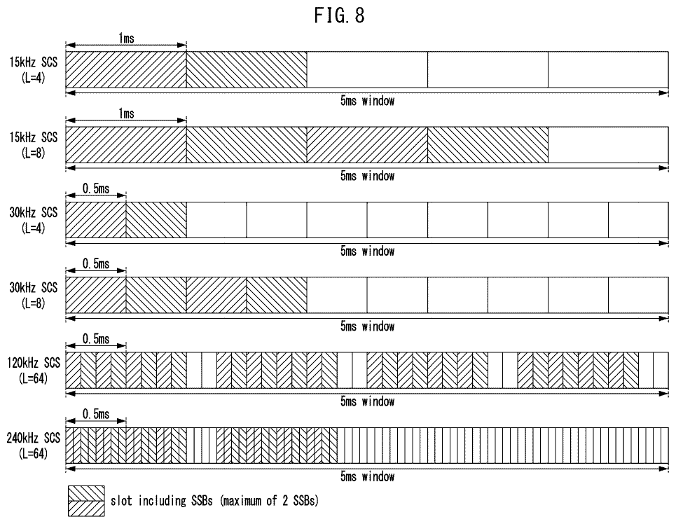

FIG. 8 is a conceptual diagram illustrating exemplary embodiments of SSB burst configuration.

Referring to FIG. 8, in a transmission procedure of SSBs (e.g., SSB burst) in radio resources to which a 120 kHz SCS is applied, the base station may transmit SSBs in 8 consecutive slots. In a transmission procedure of SSBs in radio resources to which s 240 kHz SCS is applied, the base station may transmit SSBs in 16 consecutive slots. In the radio resources to which the 120 kHz SCS or 240 kHz SCS is applied, a gap for UL transmission may be configured.

Within an SSB burst set (e.g., SS burst set), up to L transmittable positions for SSB transmissions may be defined. A value of L may vary depending on a frequency range. For example, up to 4 SSB transmissions may be possible in a 0-3 GHz frequency band of FR1, up to 8 SSB transmissions may be possible in a frequency band above 3 GHz of FR1, and up to 64 SSB transmissions may be possible in FR2. The base station may actually transmit SSBs at all L positions depending on an environment (e.g., an environment of the communication system). Alternatively, the base station may actually transmit SSBs at some of the L positions.

When the terminal receives data at a position where SSB transmission is possible, the terminal may determine whether to perform rate matching for the data based on whether an SSB is actually transmitted at the position. The base station may transmit information on the positions at which actual SSB transmissions are performed to the terminal through RMSI and/or UE-specific RRC signaling. The terminal may identify the information on the positions at which actual SSB transmissions are performed through the RMSI and/or UE-specific RRC signaling of the base station. The actual SSB transmission may indicate that the SSB is actually transmitted. The information on the positions at which actual SSB transmissions are performed may be included in the RMSI. When L is 4, a 4-bit bitmap may be used to indicate the positions at which actual SSB transmissions are performed, and when L is 8, an 8-bit bitmap may be used to indicate the positions at which actual SSB transmissions are performed. A 4-bit bitmap may refer to a bitmap having a size of 4 bits. An 8-bit bitmap may refer to a bitmap having a size of 8 bits. A bit set to a first value (e.g., 0) in the bitmap may indicate that the SSB is not transmitted at the position corresponding to the bit. A bit set to a second value (e.g., 1) in the bitmap may indicate that the SSB is transmitted at the position corresponding to the bit.

When L is 64, information on 64 positions may be delivered in a compressed form of 16 bits. The 64 positions may be divided into 8 groups of 8 positions each, and an 8-bit bitmap for the 8 groups may be configured, and an 8-bit bitmap for the 8 positions belonging to each of the 8 groups may be configured. The information on the 64 positions may be represented by 16 bits based on two 8-bit bitmaps. A transmission pattern of SSBs within the groups may be identical.

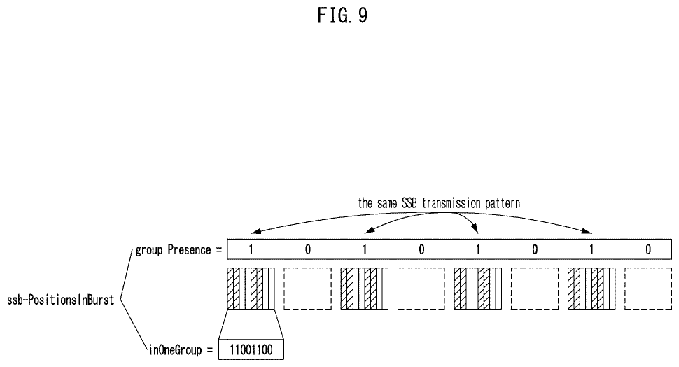

FIG. 9 is a conceptual diagram illustrating exemplary embodiments of RMSI signaling for actual SSB transmission.

Referring to FIG. 9, the base station may inform the terminal of position(s) of actual SSB transmissions through the RMSI. ssb-PositionsInBurst included in the RMSI may indicate the position(s) of the actual SSB transmissions. ssb-PositionsInBurst may include inOneGroup and/or groupPresence. Each of inOneGroup and groupPresence may have a size of 8 bits. inOneGroup may be an 8-bit bitmap and may indicate whether SSB(s) are transmitted within a group. groupPresence may be an 8-bit bitmap and may indicate whether the SSB(s) are transmitted per group. In other words, groupPresence may indicate the group(s) in which SSB(s) are transmitted.

groupPresence may indicate the group(s) in which the SSB(s) are transmitted, and the group(s) indicated by groupPresence may have the same SSB transmission pattern (e.g., same SSB transmission positions) as indicated by inOneGroup. Based on the above-described method, information on the 64 positions may be indicated by 16 bits. The signaling overhead for indicating the positions at which SSB transmissions are possible may be reduced. However, the SSB transmission positions indicated by the above-described method may differ from the positions of actual SSB transmissions.

For example, in the exemplary embodiment of FIG. 9, when the communication system (e.g., base station) operates the SSB transmission pattern of the first group and the SSB transmission pattern of the third group differently, different SSB transmission patterns may not be indicated according to the above-described method (e.g., the method based on inOneGroup and groupPresence). To solve the above-described problem, the base station may transmit a 64-bit bitmap indicating the positions of actual SSB transmissions to the terminal through UE-specific RRC signaling. When the positions of actual SSB transmissions are delivered through UE-specific RRC signaling, a full bitmap may be delivered to the terminal regardless of the value of L. The full bitmap may be a 64-bit bitmap.

The RMSI may be obtained by performing an operation to obtain configuration information of a CORESET from the SSB (e.g., PBCH), an operation of detecting a PDCCH based on the configuration information of the CORESET, an operation to obtain scheduling information of a PDSCH from the PDCCH, and an operation to receive the RMSI on the PDSCH. A transmission resource of the PDCCH may be configured by the configuration information of the CORESET. A mapping patter of the RMSI CORESET pattern may be defined as follows. The RMSI CORESET may be a CORESET used for transmission and reception of the RMSI.

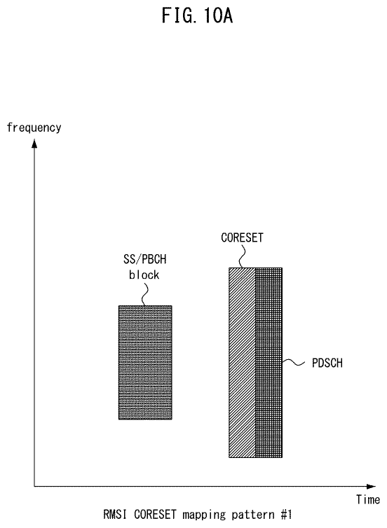

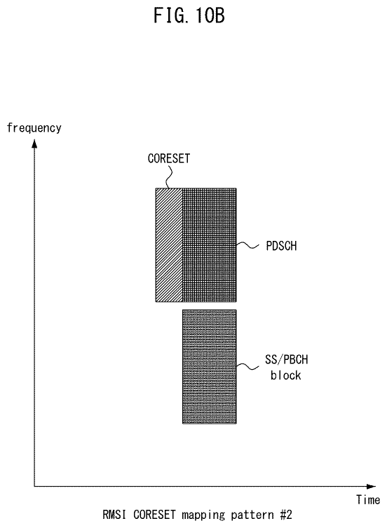

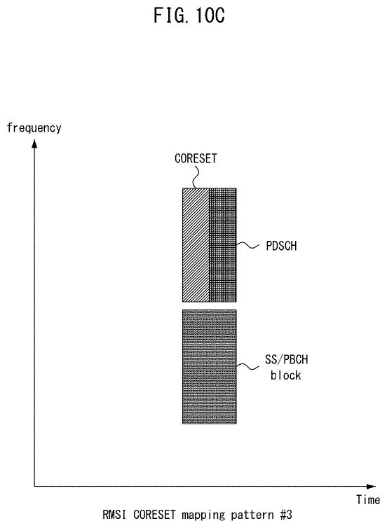

FIG. 10A is a conceptual diagram illustrating an RMSI CORESET mapping pattern #1 in a communication system, FIG. 10B is a conceptual diagram illustrating an RMSI CORESET mapping pattern #2 in a communication system, and FIG. 10C is a conceptual diagram illustrating an RMSI CORESET mapping pattern #3 in a communication system.

Referring to FIGS. 10A to 10C, one RMSI CORESET mapping pattern among the RMSI CORESET mapping patterns #1 to #3 may be used, and a detailed configuration according to the one RMSI CORESET mapping pattern may be determined. In the RMSI CORESET mapping pattern #1, the SS/PBCH block, the CORESET (i.e., RMSI CORESET), and the PDSCH (i.e., RMSI PDSCH) may be configured in a TDM scheme. The RMSI PDSCH may mean the PDSCH through which the RMSI is transmitted. In the RMSI CORESET mapping pattern #2, the CORESET (i.e., RMSI CORESET) and the PDSCH (i.e., RMSI PDSCH) may be configured in a TDM scheme, and the PDSCH (i.e., RMSI PDSCH) and the SS/PBCH block may be configured in a frequency division multiplexing (FDM) scheme. In the RMSI CORESET mapping pattern #3, the CORESET (i.e., RMSI CORESET) and the PDSCH (i.e., RMSI PDSCH) may be configured in a TDM scheme, and the CORESET (i.e., RMSI CORESET) and the PDSCH (i.e., RMSI PDSCH) may be multiplexed with the SS/PBCH block in a FDM scheme.

In the frequency band of 6 GHz or below, only the RMSI CORESET mapping pattern #1 may be used. In the frequency band of 6 GHz or above, all of the RMSI CORESET mapping patterns #1, #2, and #3 may be used. The numerology of the SS/PBCH block may be different from that of the RMSI CORESET and the RMSI PDSCH. Here, the numerology may be a subcarrier spacing. In the RMSI CORESET mapping pattern #1, a combination of all numerologies may be used. In the RMSI CORESET mapping pattern #2, a combination of numerologies (120 kHz, 60 kHz) or (240 kHz, 120 kHz) may be used for the SS/PBCH block and the RMSI CORESET/PDSCH. In the RMSI CORESET mapping pattern #3, a combination of numerologics (120 kHz, 120 kHz) may be used for the SS/PBCH block and the RMSI CORESET/PDSCH.

One RMSI CORESET mapping pattern may be selected from the RMSI CORESET mapping patterns #1 to #3 according to the combination of the numerology of the SS/PBCH block and the numerology of the RMSI CORESET/PDSCH. The configuration information of the RMSI CORESET may include Table A and Table B. Table A may represent the number of resource blocks (RBs) of the RMSI CORESET, the number of symbols of the RMSI CORESET, and an offset between an RB (e.g., starting RB or ending RB) of the SS/PBCH block and an RB (e.g., starting RB or ending RB) of the RMSI CORESET. Table B may represent the number of search space sets per slot, an offset of the RMSI CORESET, and an OFDM symbol index in each of the RMSI CORESET mapping patterns. Table B may represent information for configuring a monitoring occasion of the RMSI PDCCH. Each of Table A and Table B may be composed of a plurality of sub-tables. For example, Table A may include sub-tables 13-1 to 13-8 defined in the technical specification (TS) 38.213, and Table B may include sub-tables 13-9 to 13-13 defined in the TS 38.213. The size of each of Table A and Table B may be 4 bits.

Among three RMSI CORESET mapping patterns, in the RMSI CORESET mapping pattern #1, the terminal may perform monitoring for a Type 0 common search space (CSS) in two consecutive slots. A position n₀ of a start slot for Type 0 CSS monitoring may be determined based on Equation 1 below.

$${n}_{0} = ( O \cdot {2}^{μ} + ⌊ i \cdot M ⌋ ) mod {N}_{slot}^{frame , μ} \qquad [ Equation 1 ]$$

In Equation 1, μ may indicate a subcarrier spacing (SCS). In other words, μ may indicate a subcarrier size. When the SCS is 15 kHz, μ may be 0. When the SCS is 30 kHz, μ may be 1. When the SCS is 60 kHz, μ may be 2. When the SCS is 120 kHz, μ may be 3. i may indicate an SSB index. In unlicensed band operations, an SSB candidate index ī may be used instead of the SSB index i in Equation 1.

$${N}_{slot}^{frame , μ}$$

may indicate the number of slots having the SCS corresponding to the value μ within a radio frame. O and M may be configurable parameters for scheduling flexibility of the base station. In the procedure for determining the position of the Type 0 CSS slot, O may be used to indicate an offset between an SSB and the Type 0 CSS slot. In the monitoring procedure for two consecutive slots, M may be used to determine whether there is overlap between Type 0 CSS slots (e.g., Type 0 CSS monitoring slots). A Type 0 CSS slot may indicate a slot in which a Type 0 CSS is configured. M may be set to one of ½, 1, or 2. The degree of overlap between the two Type 0 CSS slots corresponding to one SSB index may be differently configured according to the value of M.

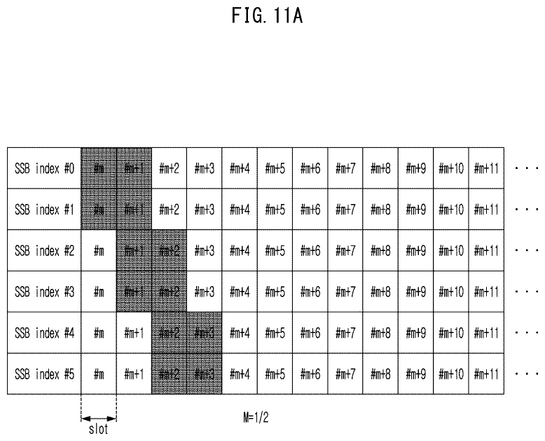

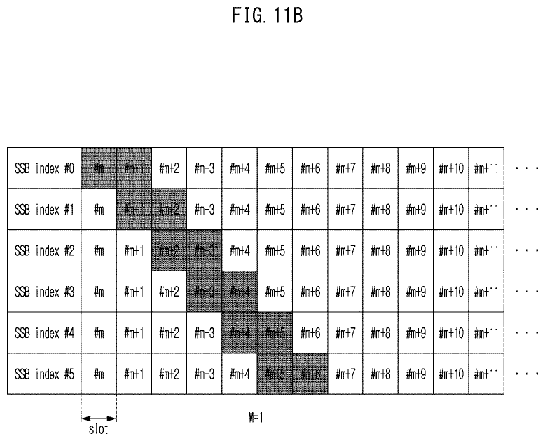

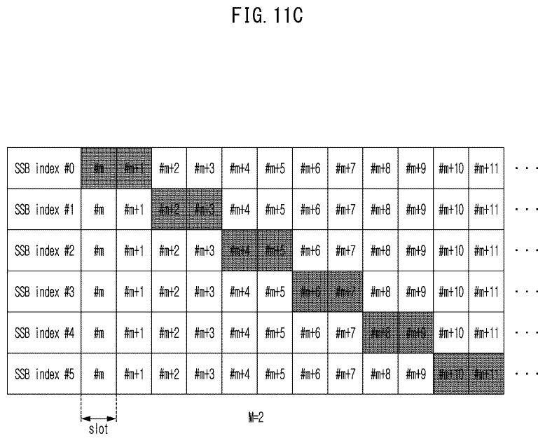

FIG. 11A is a conceptual diagram illustrating a configuration of Type 0 CSS slots corresponding to an SSB index when M is ½.

Referring to FIG. 11A, when M is ½, Type 0 CSS slots (e.g., slot #m, slot #m+1) corresponding to two SSB indexes (e.g., SSB index #0 and SSB index #1) may be configured to completely overlap. Type 0 CSS slots (e.g., slot #m+1, slot #m+2) corresponding to the next two SSB indexes (e.g., SSB index #2 and SSB index #3) may be configured to overlap with the previous Type 0 CSS slots (e.g., slot #m, slot #m+1) by only one slot (e.g., slot #m+1).

FIG. 11B is a conceptual diagram illustrating a configuration of Type 0 CSS slots corresponding to an SSB index when M is 1.

Referring to FIG. 11B, when M is 1, only the first slot among two consecutive slots (e.g., two consecutive Type 0 CSS slots) corresponding to each SSB index may be configured to overlap with the second slot among two slots corresponding to the previous SSB index.

FIG. 11C is a conceptual diagram illustrating a configuration of Type 0 CSS slots corresponding to an SSB index when M is 2.

Referring to FIG. 11C, when M is 2, two consecutive slots (e.g., two consecutive Type 0 CSS slots) corresponding to each SSB index may be configured not to overlap with two slots corresponding to the previous SSB index.

In the NR system, a PDSCH may be mapped to the time domain according to a PDSCH mapping type A or a PDSCH mapping type B. The PDSCH mapping types A and B may be defined as Table 5 below.

TABLE 5

| PDSCH | | | | | | |
|---|---|---|---|---|---|---|
| mapping | Normal CP | | | Extended CP | | |
| type | S | L | S + L | S | L | S + L |
| Type A | {0, 1, 2, 3} | {3, . . . , 14} | {3, . . . , 14} | {0, 1, 2, 3} | {3, . . . , 12} | {3, . . . , 12} |
| | (Note 1) | | | (Note 1) | | |
| Type B | {0, . . . , 12} | {2, 4, 7} | {2, . . . , 14} | {0, . . . , 10} | {2, 4, 6} | {2, . . . , 12} |

Note 1:
S = 3 is applicable only if dmrs-TypeA-Position = 3

The type A (i.e., PDSCH mapping type A) may be slot-based transmission. When the type A is used, a position of a start symbol of a PDSCH may be configured to one of {0, 1, 2, 3}. When the type A and a normal CP are used, the number of symbols constituting the PDSCH (e.g., the duration of the PDSCH) may be configured to one of 3 to 14 within a range not exceeding a slot boundary. The type B (i.e., PDSCH mapping type B) may be non-slot-based transmission. When the type B is used, a position of a start symbol of a PDSCH may be configured to one of 0 to 12. When the type B and the normal CP are used, the number of symbols constituting the PDSCH (e.g., the duration of the PDSCH) may be configured to one of {2, 4, 7} within a range not exceeding a slot boundary. A DMRS (hereinafter, referred to as ‘PDSCH DMRS’) for demodulation of the PDSCH (e.g., data) may be determined by the PDSCH mapping type (e.g., type A or type B) and an ID indicating the length. The ID may be defined differently according to the PDSCH mapping type.

Meanwhile, in the NR standardization meeting, new features (e.g., UE power saving) are being discussed. To reduce power consumption of a terminal, a long connected-discontinuous reception (C-DRX) may be configured for the terminal. The terminal may monitor a PDCCH (e.g., DCI format 2_6) before a DRX on-duration (e.g., a period of a DRX on-duration). When information included in the PDCCH indicates a wake-up, the terminal may perform a wake-up. In other words, an operation state of the terminal may transition to an active state, and the terminal in the active state (e.g., active mode) may perform a certain operation (e.g., PDCCH monitoring). The transition of the operation state of the terminal to the active state may mean that the terminal enters the active state. On the other hand, when the information included in the PDCCH indicates a sleep, the terminal may maintain a sleep state (e.g., sleep mode). According to the above-described method (e.g., UE power saving method), power consumption of the terminal may be reduced. A CRC of DCI (e.g., PDCCH) indicating the wake-up or the sleep of the terminal may be scrambled by a power saving (PS)-radio network temporary identifier (RNTI). When information included in the DCI (e.g., DCI scrambled with the PS-RNTI) is set to a first value (e.g., 0), the information may indicate the sleep. When the information included in the DCI (e.g., DCI scrambled with the PS-RNTI) is set to a second value (e.g., 1), the information may indicate the wake-up.

A paging early indication (PEI) may be introduced to reduce paging monitoring in a terminal in an RRC idle mode or an RRC inactive mode. A legacy terminal (e.g., a terminal not supporting PEI) may always monitor a periodically preconfigured paging occasion (PO). A terminal supporting PEI may monitor a DCI (e.g., PEI DCI) indicating early paging at a sufficiently earlier time than the preconfigured PO.

When the PEI DCI is received and a valid paging indication is identified from the PEI DCI, the terminal may determine that the terminal is to be paged soon and may monitor the next PO. The terminal may additionally perform an SSB measurement operation for synchronization and automatic gain control (AGC) if necessary. On the other hand, when the terminal does not receive the PEI DCI or when the terminal fails to identify a valid paging indication from the received PEI DCI, the terminal may expect that the terminal is not to be paged in the next PO. In this case, the terminal may enter a deep sleep mode and may operate with minimum power. The PEI DCI may be defined as a common DCI format 2_7. The PEI DCI may include information on a terminal subgroup. A base station may distinguish up to 8 terminal subgroups for each PO through one PEI DCI. The base station may independently transmit a PEI for each terminal subgroup.

Instead of a DCP (i.e., DCI with CRC scrambled by the PS-RNTI) and/or the PEI, a low-power wake-up signal (LP-WUS) may be used. The terminal may include a low-power wake-up receiver (LP-WUR). In other words, the terminal may include a main radio or main receiver (MR) and the LP-WUR, where the MR may be used to transmit and receive signals other than LP signals, and the LP-WUR may be used to transmit and receive LP signals. The LP signals may include the LP-WUS, an LP-synchronization signal (SS), and the like. The terminal in the sleep state may perform a LP-WUS detection operation using the LP-WUR. When an LP-WUS is detected, the operation state of the terminal may transition from the sleep state to the active state. The terminal in the active state may perform a PDCCH monitoring operation, a data reception operation, and/or a data transmission operation. The terminal in the active state may perform the above-described operation(s) using the MR. A method for replacing the PEI for a terminal in the RRC idle mode and/or RRC inactive mode is under discussion.

While the LP-WUR of the terminal performs a monitoring operation for LP-WUS detection, the MR of the terminal, which performs PDCCH monitoring and/or data transmission and reception, may maintain the sleep state. Therefore, an effect of power saving may be increased compared to the conventional method. A design method for the LP-WUS, an operation in the RRC idle/inactive mode, and/or an operation in the RRC connected mode for power saving may be required. The RRC idle/inactive mode may refer to the RRC idle mode and/or the RRC inactive mode. In the present disclosure, methods for supporting multi-beam operations for LP signals (e.g., LP-WUS) arc proposed.

An operation mode of the LP-WUR for LP-WUS monitoring may be classified into two modes. The first operation mode may be a duty-cycled (DC)-WUR mode. In the DC-WUR mode, the LP-WUR may periodically operate in the active state, and the LP-WUR in the active state may perform LP-WUS monitoring. The second operation mode may be a continuous (C)-WUR mode. In the C-WUR mode, the LP-WUR may continuously maintain the active state, and the LP-WUR in the active state may perform LP-WUS monitoring. In the DC-WUR mode, the LP-WUR may perform monitoring at a predetermined time, and in the C-WUR mode, the LP-WUR may always perform monitoring. A power saving effect in the DC-WUR mode may be greater than a power saving effect in the C-WUR mode. In the DC-WUR mode, the LP-WUR may continuously recognize (or maintain or track) a slot number, a radio frame number, and the like in order to perform monitoring only at a predetermined time. Although exemplary embodiments of the present disclosure are described based on the DC-WUR mode, the exemplary embodiments of the present disclosure may also be similarly or identically applied to the C-WUR mode.

In an environment in which multi-beam operations are supported, a base station may transmit LP signals (e.g., LP-WUS, LP-SS, etc.) using multiple beams. Methods for supporting multi-beam operations for LP signals may be differently applied depending on whether the terminal is in the RRC idle/inactive mode or in the RRC connected mode.

The terminal in the RRC idle/inactive mode may receive system information including LP-WUS configuration information (e.g., LP configuration information) from the base station. The system information may include RMSI (e.g., SIB1), SIBx, and the like. x may be a natural number. The base station may transmit the system information through a beam sweeping scheme using multiple beams. The base station may transmit LP signals (e.g., LP-WUS, LP-SS) through the beam sweeping scheme using multiple beams in the same manner as the transmission of the system information. The multiple beams for transmitting the LP signals may correspond to beams associated with actually transmitted SSBs based on ssb-PositionsInBurst within the RMSI, rather than all SSBs in an SSB burst set.

An LP-WUS occasion or LP-SS occasion (LO) for LP monitoring (e.g., LP-WUS monitoring) may include N×K LP signal monitoring occasions (MOs) in each period. One LO may correspond to one or more beams. The LP signal MOs may be LP-WUS MOs or LP-SS MOs. N may be the number of beams for transmitting LP signals, and K may be the number of LP signal MOs per beam. K may correspond to the number of POs in which the LP-WUS indicates a wake-up within the LO. The number of POs corresponding to the LO may be one of 1, 2, or 4. Alternatively, the base station may preconfigure an arbitrary value through the LP-WUS configuration information regardless of the number of POs corresponding to the LO. In other words, the LP-WUS configuration information may include the arbitrary value. The arbitrary value may indicate the value of K. The LP-WUS configuration information may be interpreted as LP configuration information depending on a context.

N may be set to the number of transmission beams (e.g., SSB transmission beams) corresponding to the number of actually transmitted SSBs based on ssb-PositionsInBurst. N may be implicitly set to the number of actually transmitted SSBs determined based on ssb-PositionsInBurst of SIB1. Alternatively, the value of N may be explicitly set through a separate parameter.

When the value of N is implicitly set to the number of actually transmitted SSBs determined based on ssb-PositionsInBurst of SIB1, the base station may actually transmit LP-WUSs in a portion of N×K LP-WUS MOs configured by the value of N. In this case, the base station may configure the actually transmitted LP-WUSs to the terminal through separate signaling. Exemplary embodiments for LP-WUS described below may be identically or similarly applied to indicate actually transmitted LP-SSs. In exemplary embodiments, an LP-WUS may be interpreted as an LP-SS, an LP-WUS resource may be interpreted as an LP-SS resource, and a bitmap for LP-WUS (e.g., LP-WUS bitmap) may be interpreted as a bitmap for LP-SS (e.g., LP-SS bitmap). In other words, the same bitmap may be applied to LP-WUS and LP-SS.

The separate signaling may be configured as a new bitmap similar to ssb-PositionsInBurst, and a length of the new bitmap may be determined based on the number of actually transmitted SSBs. For example, when ‘ssb-PositionsInBurst=10101010’, four of eight candidate SSBs are actually transmitted, so the base station may configure LP-WUS resources (e.g., LP-WUS transmission resources) in consideration of four beams. Signaling for actual LP-WUSs (e.g., LP-WUS resources used for actual LP-WUS transmission) among the LP-WUS resources may be transmitted through a bitmap consisting of four bits considering the number of actually transmitted SSBs. Based on the above-described method, since the length of the bitmap varies based on the number of actually transmitted SSBs, signaling complexity may increase. An LP-WUS resource may correspond to an LO, and one LO may correspond to one or more beams.

Signaling for actually transmitted LP-WUSs may be defined as a new bitmap having the same length as the bitmap for actually transmitted SSBs (e.g., ssb-PositionsInBurst). In the present disclosure, the bitmap for actually transmitted SSBs may be referred to as an SSB bitmap, and the bitmap for actually transmitted LP-WUSs (e.g., new bitmap) may be referred to as an LP-WUS bitmap. Alternatively, the LP-WUS bitmap may be referred to as ‘LP bitmap’. As another example, the SSB bitmap may be referred to as a first bitmap or a second bitmap, and the LP-WUS bitmap may be referred to as a second bitmap or a first bitmap. When the SSB bitmap is referred to as a first bitmap, the LP-WUS bitmap may be referred to as a second bitmap. When the SSB bitmap is referred to as a second bitmap, the LP-WUS bitmap may be referred to as a first bitmap.

The SSB bitmap may be used to indicate actually transmitted SSBs. In other words, the SSB bitmap may be used to indicate positions (e.g., occasions) where SSBs are actually transmitted. When one occasion corresponds to one beam, the SSB bitmap may be used to indicate beam(s) used for SSB transmission. The LP-WUS bitmap may be used to indicate actually transmitted LP-WUSs, and the LP-WUS bitmap may be used to indicate positions (e.g., occasions) where LP-WUSs are actually transmitted. When one occasion corresponds to one beam, the LP-WUS bitmap may be used to indicate beam(s) used the LP-WUS transmission. The LP-WUS bitmap may be configured based on the SSB bitmap.

The base station may configure the new bitmap (e.g., LP-WUS bitmap) indicating actually transmitted LP-WUSs based on the number of actually transmitted SSBs (e.g., the number of bits indicating SSB transmission within the SSB bitmap). A number of bits, which is the same as the number of bits indicating SSB transmission within the SSB bitmap, may be used within the LP-WUS bitmap to indicate whether the LP-WUS is transmitted. The bits used to indicate whether the LP-WUS is transmitted within the LP-WUS bitmap may be configured from most significant bits (MSBs) or least significant bits (LSBs).

In other words, when the number of actually transmitted SSBs is four (e.g., the number of bits indicating SSB transmission within the SSB bitmap is four), four MSBs or four LSBs among eight bits constituting the LP-WUS bitmap may be used to indicate whether the LP-WUS is transmitted. The remaining bits not used to indicate whether the LP-WUS is transmitted within the LP-WUS bitmap may be set to ‘0’. Alternatively, the remaining bits not used to indicate whether the LP-WUS is transmitted within the LP-WUS bitmap may be ignored by the base station and/or the terminal. In the above-described exemplary embodiment, when ‘ssb-PositionsInBurst=10101010’ (e.g., when the number of actually transmitted SSBs is four), the LP-WUS bitmap (e.g., new bitmap) may be configured as ‘New_Bitmap=XXXX0000’ or ‘New_Bitmap=0000XXXX’, and X may have a value of ‘1’ or ‘0’. A bit set to 1 (e.g., second value) in the LP-WUS bitmap may indicate that the LP-WUS is transmitted, and a bit set to 0 (e.g., a first value) in the LP-WUS bitmap may indicate that the LP-WUS is not transmitted.

Alternatively, a new bitmap (e.g., LP-WUS bitmap) in the same form as signaling for actually transmitted SSBs (ssb-PositionsInBurst) may be configured, and bits in the LP-WUS bitmap corresponding to a portion (e.g., bits) signaled as actually transmitted SSBs in ssb-PositionsInBurst may be used to indicate whether the LP-WUS is transmitted. In other words, bits in the LP-WUS bitmap corresponding to bits set to the first value (e.g., 0) in ssb-PositionsInBurst may not be used to indicate whether the LP-WUS is actually transmitted, and bits in the LP-WUS bitmap corresponding to bits set to the first value (e.g., 0) in ssb-PositionsInBurst may always be set to 0. Bits in the LP-WUS bitmap corresponding to bits set to the second value (e.g., 1) in ssb-PositionsInBurst may be used to indicate whether the LP-WUS is actually transmitted, and the corresponding bits may be set to 0 or 1. In the above-described exemplary embodiment, when ‘ssb-PositionsInBurst=10101010’, the LP-WUS bitmap (e.g., new bitmap) may be configured as ‘New_Bitmap=X0X0X0X0’, and X may have a value of ‘1’ or ‘0’. A bit set to 1 (e.g., the second value) in the LP-WUS bitmap may indicate that the LP-WUS is transmitted, and a bit set to 0 (e.g., the first value) in the LP-WUS bitmap may indicate that the LP-WUS is not transmitted.

The number of actually transmitted SSBs may be signaled as a bitmap in FR1. The number of actually transmitted SSBs may be signaled as a 16-bit compressed format in FR2. In FR1, the LP-WUS bitmap may be signaled in the same manner as the SSB bitmap, and in FR2, the LP-WUS bitmap may be signaled in a 16-bit compressed format in the same manner as the SSB bitmap. Alternatively, in FR2, the LP-WUS bitmap may be signaled as a bitmap consisting of 64 bits instead of a compressed format.

When the separate new bitmap is not configured, the base station may transmit LP-WUSs based on the number of actually transmitted SSBs in ssb-PositionsInBurst. In other words, the base station may transmit LP-WUSs in all LP-WUS MOs. In this case, the terminal may expect (e.g., estimate) that LP-WUSs are transmitted in all LP-WUS MOs.

A value of N explicitly configured may be set to the same value as the number of actually transmitted SSBs determined based on ssb-PositionsInBurst information. The number of actually transmitted SSBs may be signaled as a bitmap in FR1. The number of actually transmitted SSBs may be signaled as a 16-bit compressed format in FR2.

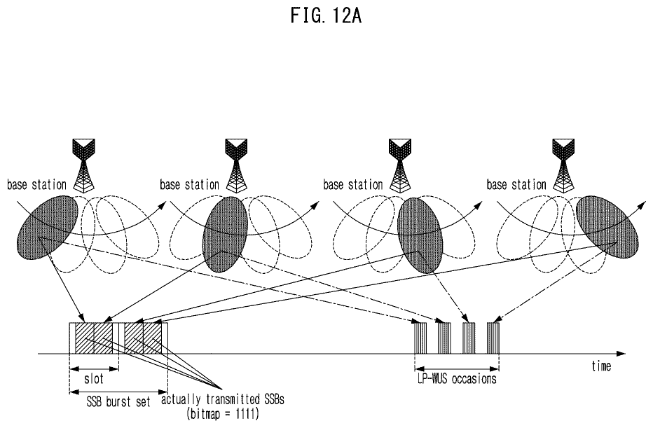

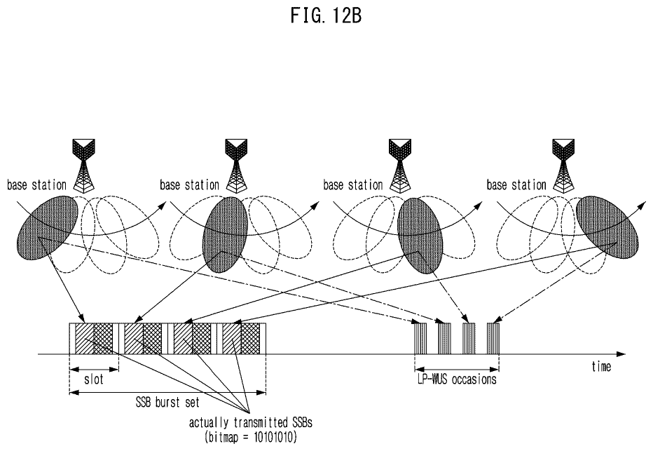

FIGS. 12A and 12B are conceptual diagrams illustrating exemplary embodiments of multi-beam operations for LP signals in the RRC idle/inactive mode.

Referring to FIGS. 12A and 12B, information on actually transmitted SSBs in FR1 may be indicated through a bitmap. In the exemplary embodiment of FIG. 12A, a maximum number of SSB transmissions may be 4. In other words, L may be 4. In the exemplary embodiment of FIG. 12B, a maximum number of SSB transmissions may be 8. In other words, L may be 8. In the exemplary embodiment of FIG. 12A, the base station may signal ‘bitmap =1111’, and the base station may transmit SSBs using four beams based on the bitmap, and may transmit LP-WUSs using the same four beams (N=4) as those for SSB transmission.

In the exemplary embodiment of FIG. 12B, the base station may signal ‘bitmap=10101010’, and the base station may transmit SSB #0, SSB #2, SSB #4, and SSB #6 among SSB #0 to #7 using four beams based on the bitmap, and may transmit LP-WUSs using the same four beams (N=4) as those for SSB transmission. In the exemplary embodiment of FIG. 9, when the base station signals ‘inOneGroup=11001100’ and ‘groupPresence =10101010’, the number of actually transmitted SSBs may be 16, and the base station may transmit LP-WUSs using the same 16 beams (N=16) as those for SSB transmission.

The base station may deliver ssb-PositionsInBurst, which indicates information on actually transmitted SSBs, to the terminal through RMSI (e.g., SIB1) and/or UE-specific RRC signaling. The terminal may have at least one of ssb-PositionsInBurst indicated by RMSI (e.g., SIB1) or ssb-PositionsInBurst indicated by UE-specific RRC signaling depending on a state (e.g., RRC state) of the terminal. When a maximum number of transmittable SSBs is 4 or 8, ssb-PositionsInBurst indicated by RMSI (e.g., SIB1) and ssb-PositionsInBurst indicated by UE-specific RRC signaling may be identical. When a maximum number of transmittable SSBs is 64, ssb-PositionsInBurst indicated by RMSI (e.g., SIB1) may indicate a compressed 16-bit bitmap, and ssb-PositionsInBurst indicated by UE-specific RRC signaling may indicate a 64-bit bitmap. The UE-specific RRC signaling may deliver more accurate information on actually transmitted SSBs.

When the terminal receives one of ssb-PositionsInBurst indicated by RMSI (e.g., SIB1) or ssb-PositionsInBurst indicated by UE-specific RRC signaling, the terminal may determine (e.g., identify) the number of actually transmitted SSBs based on the received information and may implicitly determine that the same number N of beams as the determined number are used for LP-WUS transmission.

The terminal may receive ssb-PositionsInBurst indicated by RMSI (e.g., SIB1) and ssb-PositionsInBurst indicated by UE-specific RRC signaling, and the number of actually transmitted SSBs indicated by ssb-PositionsInBurst indicated by RMSI (e.g., SIB1) may differ from the number of actually transmitted SSBs indicated by ssb-PositionsInBurst indicated by UE-specific RRC signaling. In this case, since the UE-specific RRC signaling delivers more accurate information than RMSI, the terminal may determine (e.g., identify) the number N of beams used for LP-WUS transmission based on the number of actually transmitted SSBs identified from the UE-specific RRC signaling.

In another method, the terminal may receive ssb-PositionsInBurst indicated by RMSI (e.g., SIB1) and ssb-PositionsInBurst indicated by UE-specific RRC signaling, and the number of actually transmitted SSBs indicated by ssb-PositionsInBurst indicated by RMSI (e.g., SIB1) may differ from the number of actually transmitted SSBs indicated by ssb-PositionsInBurst indicated by UE-specific RRC signaling. In this case, the terminal may determine (e.g., identify) the number N of beams used for LP-WUS transmission based on the number of actually transmitted SSBs indicated by RMSI, which may have been delivered to many terminals. Alternatively, since the LP-WUS is transmitted in a beam sweeping manner in the RRC idle/inactive mode, the terminal may determine (e.g., identify) the number N of beams used for LP-WUS transmission based on the number of actually transmitted SSBs indicated by RMSI, which can be acquired by the terminal in the RRC idle/inactive mode.

The terminal may receive ssb-PositionsInBurst indicated by RMSI (e.g., SIB1) and ssb-PositionsInBurst indicated by UE-specific RRC signaling, and the number of actually transmitted SSBs indicated by ssb-PositionsInBurst indicated by RMSI (e.g., SIB1) may be the same as the number indicated by ssb-PositionsInBurst indicated by UE-specific RRC signaling. In this case, the terminal may selectively use one piece of information (e.g., ssb-PositionsInBurst indicated by RMSI (e.g., SIB1) or ssb-PositionsInBurst indicated by UE-specific RRC signaling) depending on its implementation, and may determine (e.g., identify) the number N of beams used for LP-WUS transmission based on the selected information.

In another method, the base station may transmit LP-WUSs using beams corresponding to a maximum number of SSB transmissions in the frequency domain regardless of ssb-PositionsInBurst information. In a frequency band below 3 GHz in FR1, the base station may transmit LP-WUSs using four beams (N=4). In a frequency band of 3 GHz to 7.125 GHz in FR1, the base station may transmit LP-WUSs using eight beams (N=8). In FR2, the base station may transmit LP-WUSs using 64 beams (N=64).

In another method, the base station may separately configure a value of N, which is the number of beams for LP-WUS transmission, to the terminal through system information and/or UE-specific RRC signaling regardless of ssb-PositionsInBurst or the maximum number of SSB transmissions in the frequency domain. To indicate the number of beams for LP-WUS transmission, the base station may perform signaling for a beam pattern similar to ssb-PositionsInBurst, rather than the number of beams. In this case, the beam pattern signaled by the base station may be a subset of the beam pattern signaled through ssb-PositionsInBurst.

The above-described method may be identically or similarly applied when LP-SSs are transmitted through multiple beams in addition to LP-WUS transmission. LP-SS may have a one-to-one relationship (e.g., one-to-one mapping relationship) with LP-WUS. In other words, one LP-SS may be mapped to one LP-WUS. LP-SS may be one type of LP signal, and LP-WUS may be another type of LP signal. In the present disclosure, an LP signal may indicate an LP-SS and/or an LP-WUS. The LP-SS transmission and the LP-WUS transmission may be performed based on the one-to-one relationship. The base station may transmit one LP-SS and may transmit an LP-WUS corresponding to the one LP-SS. The base station may configure a transmission occasion of the LP-SS in consideration of the number of actually transmitted SSBs and may configure a bitmap indicating whether LP-SS and LP-WUS are actually transmitted identically or similarly to the above-described new bitmap (e.g., LP-WUS bitmap). When the separate bitmap is not configured, the base station may transmit LP-SSs based on the total number of actually transmitted SSBs. In other words, the base station may transmit LP-SSs in all LP-SS transmission occasions. The terminal may expect (e.g., estimate) that LP-SSs are transmitted in all LP-SS transmission occasions.

The terminal in the RRC connected mode may receive LP configuration information (e.g., LP-WUS configuration information) through UE-specific RRC signaling. The base station may transmit the UE-specific RRC signaling through a PDSCH based on beam information indicated by Transmission Configuration Indicator (TCI) information, and the terminal may receive the PDSCH carrying the UE-specific RRC signaling based on the beam information indicated by the TCI information. Even in the RRC connected mode, when the base station transmits LP signals (e.g., LP-WUS, LP-SS) in a beam sweeping manner using multiple beams, the base station may perform the transmission (e.g., transmission of LP configuration information, LP-WUS transmission, LP-SS transmission) based on the above-described method. A method for transmitting an LP signal in consideration of a case where the LP signal is not transmitted in a beam sweeping manner in the RRC connected mode may be required.

In an NR system, the base station may transmit beam indication (e.g., TCI) for transmission of a PDSCH, which is a downlink data channel, through a three-step process. The base station may configure up to 128 TCI states for a BWP in which the PDSCH is transmitted through RRC signaling (e.g., PDSCH-Config), may activate up to 8 of the 128 TCI states through MAC CE signaling, and may dynamically indicate one of the up to 8 TCI states through a DCI.

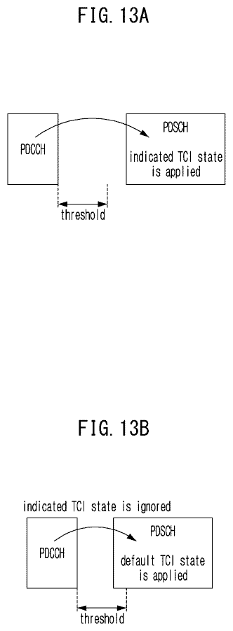

FIGS. 13A and 13B are conceptual diagrams illustrating exemplary embodiments of a PDSCH scheduling offset due to beam switching delay.

Referring to FIGS. 13A and 13B, an offset equal to or greater than a certain time may exist between a PDCCH in which a DCI is transmitted and a PDSCH to which a TCI state indicated by the DCI is applied. When a time interval between the PDCCH and the PDSCH is less than a certain time (e.g., threshold), the terminal may assume that the PDSCH is transmitted based on a default TCI state rather than the TCI state indicated by the DCI. The base station may configure the default TCI state in advance to the terminal.

For a PDCCH, which is a downlink control channel, the base station may configure up to 64 TCI states per CORESET through RRC signaling and may activate one of the 64 TCI states through a MAC CE. The terminal may assume that the PDCCH is transmitted based on the TCI state activated through the MAC CE. Unlike a PDSCH, dynamic indication of a TCI state for a PDCCH through a DCI may not be supported.

In a method of separately indicating a PDCCH (e.g., CORESET) beam and a PDSCH beam, there may be problems of increased complexity, signaling overhead, and/or delay time. To address such problems, a unified TCI framework for simultaneously indicating a PDCCH (e.g., CORESET) beam and a PDSCH beam (or a PUSCH beam) may be newly introduced. When the unified TCI framework is applied, the terminal may receive one TCI state from the base station, the one TCI state indicating information on both a downlink transmission beam and an uplink transmission beam. The TCI state may indicate that the same beam is used for both DL and UL. The TCI state may indicate a beam for a joint of a DL beam and a UL beam. When the unified TCI framework is applied, the terminal may assume that the indicated beam (e.g., indicated TCI state) is applied to both the PDCCH (e.g., CORESET) and the PDSCH (or the PUSCH).

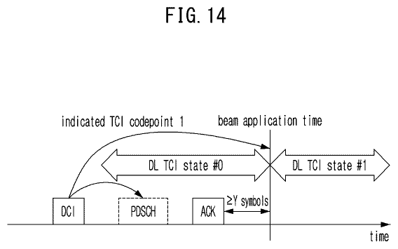

FIG. 14 is a conceptual diagram illustrating exemplary embodiments of a beam application time (BAT).

Referring to FIG. 14, a TCI state indicated through a DCI may be applied from the first slot after Y symbols from the last symbol of HARQ-ACK (e.g., ACK or NACK) for a PDSCH scheduled by the DCI. Y may be a natural number. The base station may indicate a value of Y to the terminal through signaling. Alternatively, a value of Y may be predefined in the technical specifications. The TCI state indicated through the DCI may be one of a plurality of TCI states that are pre-activated through a MAC CE.

When the base station transmits an LP signal (e.g., LP-WUS, LP-SS) to a terminal in the RRC connected mode, information on a beam (e.g., TCI state) of the LP signal may be configured similarly to the aforementioned PDSCH or the aforementioned PDCCH (e.g., CORESET). The base station may configure up to X₁ TCI states through RRC signaling, may activate up to X₂ TCI states among the X₁ TCI states through MAC CE signaling, and may dynamically indicate one TCI state for LP signal transmission (e.g., LP-WUS transmission, LP-SS transmission) among the X₂ activated TCI states through a DCI. X₁ and X₂ may be natural numbers.

In another method, the base station may configure up to X₃ TCI states through RRC signaling and may activate one TCI state for LP signal transmission (e.g., LP-WUS transmission, LP-SS transmission) among the X₃ TCI states through MAC CE signaling. X₃ may be a natural number. Each of the DCI or the MAC CE for TCI state activation or indication may be a DCI or MAC CE for activation of LP monitoring (e.g., LP-WUS monitoring, LP-SS monitoring). The base station may transmit an indication for activation of LP monitoring through a DCI or a MAC CE. In this case, the base station may transmit information for TCI state activation or indication along with the indication for activation of LP monitoring. Alternatively, each of the DCI or MAC CE for activation (or indication) of a TCI state may be independent from the DCI or MAC CE for activation of LP monitoring.

When the terminal supports the unified TCI framework, the base station may indicate a TCI state for LP monitoring through the unified TCI framework. The base station may activate some of the TCI states configured in advance through RRC signaling via a MAC CE, and may indicate one of the activated TCI states through a DCI. The above-described TCI state indication method may be similarly or identically applied to other DL channels/signals. The other DL channels/signals may refer to other DL channels and/or other DL signals. When a TCI state for reception of other DL channels/signals is configured through the unified TCI framework, even if the terminal transitions to the sleep state before another new TCI state is indicated, the terminal may perform LP monitoring based on the TCI state configured through the unified TCI framework (e.g., the latest TCI state, the most recent TCI state). In this case, the applied TCI state may be the latest TCI state (e.g., the most recent TCI state) indicated through the unified TCI framework before the terminal transitions to the sleep state. The transition of the terminal's operation state to the sleep state may mean that the terminal enters the sleep state.

Alternatively, the base station may configure a separate unified TCI framework for LP signal (e.g., LP-WUS, LP-SS) independently from other DL channels/signals. In this case, the base station may configure a plurality of TCI states through separate RRC signaling, may activate one or more TCI states among the configured TCI states through a separate MAC CE, and may indicate one of the activated TCI states among the one or more TCI states to the terminal through a separate DCI. When the terminal supports the unified TCI framework, and the unified TCI framework for DL channels/signals or the separate unified TCI framework is not configured to the terminal, the base station may configure a TCI state for LP monitoring (e.g., LP-WUS monitoring, LP-SS monitoring) based on the above-described method. For example, the base station may configure a TCI state for LP monitoring based on configuration of TCI states through RRC signaling, activation of TCI states through a MAC CE, and indication of one TCI state through a DCI. Alternatively, the base station may configure a TCI state for LP monitoring based on configuration of TCI states through RRC signaling and activation of one TCI state through a MAC CE.

Generally, since the LP-WUR operates in the sleep state, it may be difficult to apply the above-described TCI state indication method to indicate a transmission beam of LP-WUS. When the base station transmits an LP-WUS to a terminal in the RRC connected mode, information on a transmission beam (e.g., TCI state) of the LP-WUS may be configured in advance to the terminal through cell-specific RRC signaling or UE-specific RRC signaling together with LP-WUS configuration information. In order to support the terminal to perform LP-WUS monitoring in a plurality of LP-WUS occasions, the base station may configure a TCI state for each of the LP-WUS occasions to the terminal. If a separate TCI state for LP-WUS monitoring is not configured to the terminal, the terminal may perform LP-WUS monitoring by applying a TCI state associated with an SSB used in an initial access procedure.

In another method, the terminal may assume that the same TCI state as the TCI state used in the most recent PDCCH (e.g., CORESET) transmission or the most recent PDSCH transmission before LP-WUS monitoring is applied to LP-WUS transmission. If information on the TCI state applied to the PDCCH (e.g., CORESET) transmission or the PDSCH transmission before the terminal's operation state transitions to the sleep state (e.g., the state where the terminal performs LP-WUS monitoring) is valid, the terminal may assume that the TCI state is also applied to LP-WUS transmission (e.g., LP-WUS transmission in the sleep state).

The criteria for determining that the TCI state is valid may be as follows. When a time of configuring TCI state information (e.g., reception time of the TCI state information) and an LP-WUS monitoring time exist within a certain time or offset, the terminal may determine that the TCI state information is valid. When an interval between the TCI state information configuration time (e.g., reception time) and the LP-WUS monitoring time exceeds the certain time or offset, the terminal may determine that the TCI state information is not valid. When the TCI state information is determined to be not valid, the terminal may assume that a default TCI state is applied to LP-WUS transmission. The base station may configure a default TCI state for LP-WUS to the terminal in advance together with LP-WUS configuration information.

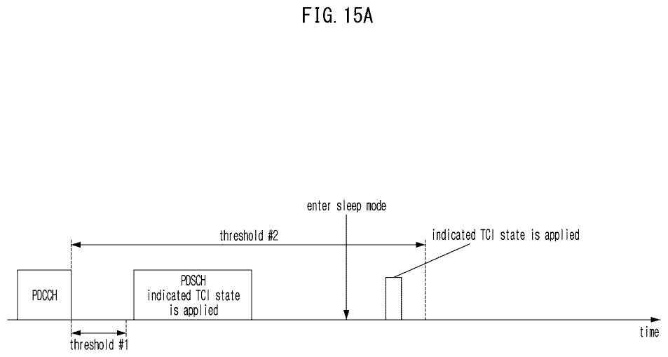

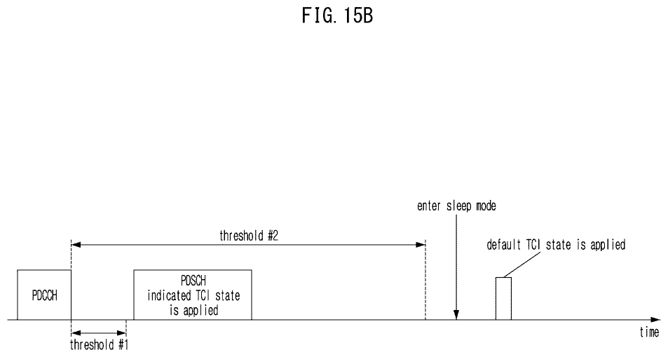

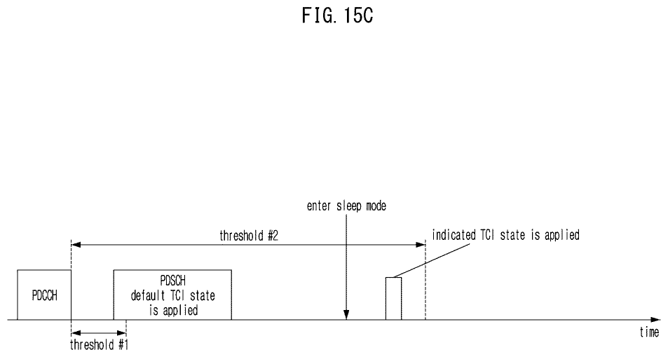

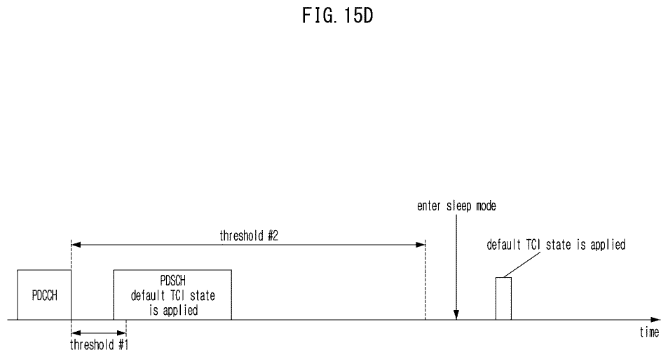

FIGS. 15A, 15B, 15C, and 15D are conceptual diagrams illustrating exemplary embodiments of LP beam application for a PDSCH.

Referring to FIGS. 15A, 15B, 15C, and 15D, an LP beam may refer to a beam used for transmission and reception of an LP signal, and the LP beam may be referred to as an LP-WUS beam, an LP-SS beam, and the like. A threshold #1 may be the same parameter as the threshold used to determine whether the TCI state indicated through the PDCCH is applied to the PDSCH in the exemplary embodiments of FIGS. 13A and 13B. The threshold #1 may start from an end time of a PDCCH. A threshold #2 may be a parameter for determining whether a TCI state is applied to an LP signal (e.g., LP-WUS, LP-SS) proposed in the present disclosure. The threshold #2 may start from the end time of the PDCCH.

In the exemplary embodiment of FIG. 15A, since a time interval between the PDCCH and a PDSCH is greater than the threshold #1, the terminal may determine that a TCI state indicated through a DCI in the PDCCH is applied to the PDSCH. Since a time at which the terminal enters the sleep state and an LP monitoring time of the terminal (e.g., LP-WUS monitoring time, LP-SS monitoring time) are within the threshold #2, the terminal may determine that the same TCI state (e.g., the TCI state indicated through the DCI) is applied to the LP signal. Therefore, the terminal may perform a monitoring operation (e.g., reception operation) for the LP signal based on the TCI state indicated through the DCI.

In the exemplary embodiment of FIG. 15B, although the TCI state indicated through the DCI may be applied to the PDSCH, since the LP-WUS monitoring time of the terminal in the sleep state is beyond the threshold #2, the terminal may determine that a default TCI state, not the TCI state indicated through the DCI, is applied to the LP signal. Therefore, the terminal may perform a monitoring operation (e.g., reception operation) for the LP signal based on the default TCI state. In the exemplary embodiment of FIG. 15C, since the time interval between the PDCCH and the PDSCH is less than the threshold #1, a default TCI state, not the TCI state indicated through the DCI, may be applied to the PDSCH, and since the LP-WUS monitoring time of the terminal in the sleep state is within the threshold #2, the TCI state indicated through the DCI may be applied to the LP signal. Therefore, the terminal may perform a monitoring operation (e.g., reception operation) for the LP signal based on the TCI state indicated through the DCI.

In the exemplary embodiment of FIG. 15D, since the time interval between the PDCCH and the PDSCH is less than the threshold #1, a default TCI state, not the TCI state indicated through the DCI, may be applied to the PDSCH, and since the LP monitoring time of the terminal in the sleep state is beyond the threshold #2, a default TCI state, not the TCI state indicated through the DCI, may be applied to the LP signal. Therefore, the terminal may perform a monitoring operation (e.g., reception operation) for the LP signal based on the default TCI state.

The default TCI state applied to the PDSCH and the default TCI state applied to the LP signal may be configured differently. The default TCI state may be configured differently for each channel/signal. The time interval of the threshold #2 may be expressed in terms of the number of slots, the number of subframes, or an absolute time. The time at which the threshold #2 is applied may be a time when the operation state of the terminal transitions to the sleep state, rather than the time when the TCI state is indicated.

The TCI state indicated through the PDCCH may be applied to the PDSCH (e.g., PDSCH transmission and/or reception). Identically or similarly to the above-described exemplary embodiments, a TCI state indicated through a PDCCH may be applied to a PDCCH (e.g., PDCCH transmission and/or reception). The application of a TCI state indicated through a PDCCH to a PDCCH may mean that the TCI state indicated through the PDCCH is applied to CORESET monitoring. When the unified TCI framework is applied, the above-described exemplary embodiments may be applied similarly or identically.

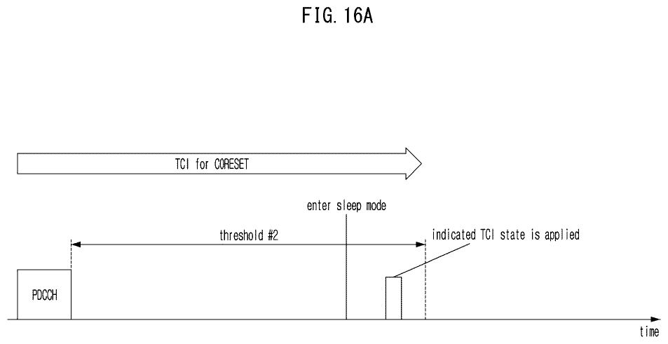

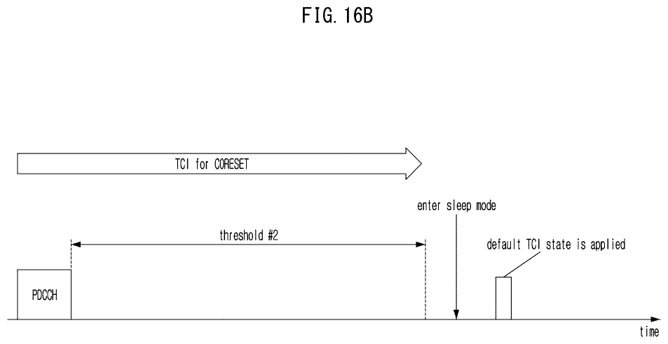

FIGS. 16A and 16B are conceptual diagrams illustrating exemplary embodiments of LP beam application for a PDCCH.

Referring to FIGS. 16A and 16B, an LP beam may refer to a beam used for transmission and reception of an LP signal, and the LP beam may be referred to as an LP-WUS beam, an LP-SS beam, and the like. The terminal may assume that a TCI state is applied to a PDCCH (e.g., CORESET). For example, the terminal may determine that a TCI state indicated through a MAC CE among TCI states configured in advance through RRC signaling is applied to an LP signal (e.g., LP-WUS, LP-SS). When a preset threshold (e.g., threshold #2) elapses, the terminal may apply a default TCI state, not the TCI state applied to the PDCCH (e.g., CORESET). When the terminal assumes a TCI state (e.g., applied TCI state) indicated in the unified TCI framework, the terminal may determine, based on the threshold #2, whether the TCI state indicated by the unified TCI framework is valid at an LP monitoring time. If the TCI state indicated by the unified TCI framework is valid at the LP monitoring time, the terminal may determine that the indicated TCI state is applied to the LP signal. In other words, the terminal may perform a monitoring operation (e.g., reception operation) for the LP signal based on the indicated TCI state. If the TCI state indicated by the unified TCI framework is not valid at the LP-WUS monitoring time, the terminal may determine that a default TCI state is applied to the LP signal. In other words, the terminal may perform a monitoring operation (e.g., reception operation) for the LP signal based on the default TCI state.

A valid duration of the TCI state may be within a certain time (e.g., threshold #1 in FIG. 15) after the TCI state is indicated and before another specific time (e.g., threshold #2 in FIG. 15). Alternatively, another criterion other than the threshold #1 may be applied to determine the valid duration of the TCI state. For example, the terminal may determine that the TCI state is valid from a certain time (e.g., threshold #3) after transmission of HARQ-ACK (e.g., ACK/NACK feedback) for PDSCH reception scheduled by the DCI (e.g., PDCCH) that indicates the TCI state or from a transmission time of the HARQ-ACK after the reception of the DCI including the TCI state.

In another method for applying a TCI state to an LP-WUS, a terminal that wakes up based on an LP-WUS may apply a TCI state configured for a CORESET associated with a PDCCH to be monitored during a C-DRX on-duration. For example, assuming that the CORESET in which the PDCCH to be monitored during the C-DRX on-duration is to be transmitted is a CORESET #X, the base station may configure up to 64 TCI states for the terminal through RRC signaling and may activate one of the 64 TCI states through a MAC CE to indicate a TCI state for the CORESET #X. The terminal may apply the activated TCI state (e.g., the indicated TCI state) to LP-WUS monitoring.

When multiple CORESETs are associated with PDCCHs to be monitored during the C-DRX on-duration, the terminal may apply a TCI state applied to (e.g., associated with) a CORESET having the smallest index or a CORESET having the largest index among the multiple CORESETs. Alternatively, the base station may indicate a specific CORESET index to the terminal in advance, and the terminal may apply a TCI state applied to the specific CORESET index indicated by the base station. Alternatively, the base station may configure an LP-WUS MO for each of the CORESETs. The terminal may perform LP-WUS monitoring by applying a TCI state applied to a CORESET associated with each LP-WUS MO.

When the base station configures the unified TCI framework and the terminal supports the above-described unified TCI framework, the terminal may indicate a TCI state for LP-WUS monitoring (or LP-SS monitoring) based on the above-described unified TCI framework. When the unified TCI framework is not configured, the base station may indicate a TCI state for LP-WUS monitoring (or LP-SS monitoring) based on the exemplary embodiments of the present disclosure, and the terminal may perform LP-WUS monitoring (or LP-SS monitoring) based on the indicated TCI state.

When the sleep state of the terminal continues for a certain time duration or more, the terminal may apply a default TCI state instead of the indicated TCI state. The default TCI state may be included in LP configuration information (e.g., LP-WUS configuration information). In other words, the base station may configure the default TCI state to the terminal in advance through the LP configuration information.

In another method, an application method of a TCI state for LP-WUS monitoring may be applied differently based on a method of activating LP-WUS monitoring of the terminal. When a PDCCH for activating LP-WUS monitoring of the terminal exists separately, the terminal may apply a TCI state configured for a CORESET for PDCCH reception to LP-WUS monitoring. When LP-WUS monitoring is initiated without detecting a PDCCH for a certain time duration (e.g., when LP-WUS monitoring is initiated based on a specific timer (e.g., timer #A)), the terminal may apply a TCI state configured for a CORESET of a PDCCH or a TCI state configured for a PDSCH, which is received (immediately) before a start of timer #A, to LP-WUS monitoring. The PDCCH may be the most recently received PDCCH before the start of timer #A, and the PDSCH may be the most recently received PDSCH before the start of timer #A.

When LP-WUS monitoring is automatically activated at a time when another specific timer (e.g., timer #B) expires, regardless of whether a PDCCH is received, the terminal may apply a TCI state configured for a CORESET of the most recently received PDCCH or a TCI state configured for the most recently received PDSCH to LP-WUS monitoring at an expiration time of timer #B. The specific timers (e.g., timer #A and/or timer #B) may be included in LP-WUS configuration information. In other words, the base station may configure the specific timers (e.g., timer #A and/or timer #B) to the terminal in advance through the LP-WUS configuration information.

The base station may transmit an LP signal (e.g., LP-WUS, LP-SS) by applying a specific TCI state. In this case, the terminal may transmit the LP signal based on a specific antenna port. Since the LP signal is transmitted in a beam sweeping manner through multiple beams in the RRC idle/inactive mode, the LP signal may be transmitted based on the same antenna port (e.g., antenna port 4000 and/or higher) as an existing SSB transmission.

In the RRC connected mode, the antenna port may vary depending on the applied TCI state. When the TCI state for the LP signal is the TCI state applied to a PDSCH, the base station may transmit the LP signal based on an antenna port for PDSCH transmission (e.g., antenna port 1000 and/or higher). When the TCI state for the LP signal is the TCI state applied to a PDCCH, the base station may transmit the LP signal based on an antenna port for PDCCH transmission (e.g., antenna port 2000 and/or higher). When the TCI state for the LP signal is the TCI state applied to an SSB, the base station may transmit the LP signal based on an antenna port (e.g., antenna port 4000 and/or higher).

As another method, since the antenna port is a virtual concept, even when various TCI states are applied based on the RRC idle mode, RRC active mode, and/or RRC connected mode, the base station may transmit the LP signal based on a separate new antenna port (e.g., antenna port 6000 and/or higher), regardless of the channel/signal to which the TCI state is applied.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
receiving, from a base station, a first bitmap indicating whether a synchronization signal block (SSB) is transmitted;
receiving the SSB from the base station based on the first bitmap;
receiving, from the base station, a second bitmap indicating whether a low-power (LP) signal is transmitted; and
receiving the LP signal from the base station based on the second bitmap,
wherein the second bitmap indicates a beam through which the LP signal is transmitted, and the beam is configured based on an actually transmitted SSB indicated by the first bitmap.

2. The method of claim 1, wherein a bit in the second bitmap corresponding to a bit set to a first value in the first bitmap is not used to indicate whether the LP signal is transmitted, a bit in the second bitmap corresponding to a bit set to a second value in the first bitmap is used to indicate whether the LP signal is transmitted, the first value indicates that the SSB is not transmitted, and the second value indicates that the SSB is transmitted.

3. The method of claim 1, wherein a number of bits equal to a number of bits set to a second value in the first bitmap are used in the second bitmap to indicate whether the LP signal is transmitted, a bit set to a first value in the first bitmap indicates that the SSB is not transmitted, and a bit set to a second value in the first bitmap indicates that the SSB is transmitted.

4. The method of claim 3, wherein the bits used to indicate whether the LP signal is transmitted in the second bitmap are configured starting from a most significant bit (MSB) or a least significant bit (LSB).

5. The method of claim 1, wherein the second bitmap is configured based on values of respective bits in the first bitmap, and a size of the second bitmap is equal to a size of the first bitmap.

6. The method of claim 1, wherein the LP signal is a low-power wake-up signal (LP-WUS) or a low-power synchronization signal (LP-SS), and the LP-WUS has a one-to-one mapping relationship with the LP-SS.

7. The method of claim 1, wherein the UE operates in an active state or a sleep state, the UE in the active state receives at least one of the first bitmap, the SSB, or the second bitmap, and the UE in the sleep state receives the LP signal.

8. The method of claim 1, wherein the UE operates in a radio resource control (RRC) idle mode or RRC inactive mode.

9. A method of a base station, comprising:
transmitting, to a user equipment (UE), a first bitmap indicating whether a synchronization signal block (SSB) is transmitted;
transmitting the SSB to the UE based on the first bitmap;
transmitting, to the UE, a second bitmap indicating whether a low-power (LP) signal is transmitted; and
transmitting the LP signal to the UE based on the second bitmap,
wherein the second bitmap indicates a beam through which the LP signal is transmitted, and the beam is configured based on an actually transmitted SSB indicated by the first bitmap.

10. The method of claim 9, wherein a bit in the second bitmap corresponding to a bit set to a first value in the first bitmap is not used to indicate whether the LP signal is transmitted, a bit in the second bitmap corresponding to a bit set to a second value in the first bitmap is used to indicate whether the LP signal is transmitted, the first value indicates that the SSB is not transmitted, and the second value indicates that the SSB is transmitted.

11. The method of claim 9, wherein a number of bits equal to a number of bits set to a second value in the first bitmap are used in the second bitmap to indicate whether the LP signal is transmitted, a bit set to a first value in the first bitmap indicates that the SSB is not transmitted, and a bit set to a second value in the first bitmap indicates that the SSB is transmitted.

12. The method of claim 11, wherein the bits used to indicate whether the LP signal is transmitted in the second bitmap are configured starting from a most significant bit (MSB) or a least significant bit (LSB).

13. The method of claim 9, wherein the second bitmap is configured based on values of respective bits in the first bitmap, and a size of the second bitmap is equal to a size of the first bitmap.

14. The method of claim 9, wherein the LP signal is a low-power wake-up signal (LP-WUS) or a low-power synchronization signal (LP-SS), and the LP-WUS has a one-to-one mapping relationship with the LP-SS.

15. The method of claim 9, wherein the UE operates in an active state or a sleep state, the UE in the active state receives at least one of the first bitmap, the SSB, or the second bitmap, and the UE in the sleep state receives the LP signal.

16. The method of claim 9, wherein the UE operates in a radio resource control (RRC) idle mode or RRC inactive mode.

17. A user equipment (UE) comprising at least one processor, wherein the at least one processor causes the UE to perform:
receiving, from a base station, a first bitmap indicating whether a synchronization signal block (SSB) is transmitted;
receiving the SSB from the base station based on the first bitmap;
receiving, from the base station, a second bitmap indicating whether a low-power (LP) signal is transmitted; and
receiving the LP signal from the base station based on the second bitmap,
wherein the second bitmap indicates a beam through which the LP signal is transmitted, and the beam is configured based on an actually transmitted SSB indicated by the first bitmap.

18. The UE of claim 17, wherein a bit in the second bitmap corresponding to a bit set to a first value in the first bitmap is not used to indicate whether the LP signal is transmitted, a bit in the second bitmap corresponding to a bit set to a second value in the first bitmap is used to indicate whether the LP signal is transmitted, the first value indicates that the SSB is not transmitted, and the second value indicates that the SSB is transmitted.

19. The UE of claim 17, wherein a number of bits equal to a number of bits set to a second value in the first bitmap are used in the second bitmap to indicate whether the LP signal is transmitted, a bit set to a first value in the first bitmap indicates that the SSB is not transmitted, and a bit set to a second value in the first bitmap indicates that the SSB is transmitted.

20. The UE of claim 19, wherein the bits used to indicate whether the LP signal is transmitted in the second bitmap are configured starting from a most significant bit (MSB) or a least significant bit (LSB).
